(19) United States
(12) Patent Application Publication
(10) Pub. No.: US 2009/0231620 A1
(43) Pub. Date: Sep. 17, 2009

(54) PRINTING OF PRINTING JOB SAVED IN IMAGE FORMING APPARATUS WITH CHANGED PRINT FORMAT

(75) Inventor: Takayuki Kaneko, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/403,293

(22) Filed: Mar. 12, 2009

(30) Foreign Application Priority Data
Mar. 13, 2008 (JP) 2008-064694

(51) Int. Cl. G06F 3/12

(52) U.S. Cl. 358/1.15

(57) ABSTRACT

A job ticket included in a received printing job is analyzed to determine a processing method. The job ticket specifies a print format and the processing method used to output data for printing. When the processing method is determined to be a printing and saving process, the data is outputted for printing by generating printing data based on saving data and the job ticket, and second intermediate data for reprinting is generated from first intermediate data and thus saved. The printing data is a base for the first intermediate data that is a base for data for printing, and reflects the print format. The saving data is included in the received printing job, does not reflect the print format, and is suitable for changing the print format. The second intermediate data does not reflect the print format, and is suitable for changing the print format.

### BACKGROUND OF THE INVENTION

1. Field of the Invention

The present invention relates to a method of saving data in an image forming apparatus and a method of using the saved data.

2. Description of the Related Art

In order to print printing data with an image forming apparatus (printing apparatus) after transmitting the printing data to the image forming apparatus from an information processing apparatus (personal computer), it is a conventional practice that the information processing apparatus creates a PDL (Page Description Language) document by processing the printing data with a desired print format by use of a printer driver installed in the information processing apparatus, and thereafter transmits the PDL document to the image forming apparatus. Here, the image forming apparatus receives the PDL document from the information processing apparatus, and prints the PDL document by developing the PDL document into a printable dot image.

In addition, the image forming apparatus is capable of saving the PDL document and the dot image developed from the PDL document in its auxiliary storage, and can reprint the PDL document in a different occasion. This configuration enables reprinting of the saved PDL document with the same print format as the PDL document and dot image have been saved.

However, the PDL document and dot image saved in the auxiliary storage are in the form in which a print setting specified by a user is reflected. For this reason, it is difficult to restore the saved PDL document and dot image to the normally-formatted PDL document and dot image, and also to change the saved PDL document and dot image into a differently-formatted PDL document and dot image. Particularly, a configuration for saving the dot image has a problem that the printing quality is deteriorated when the print format along with scaling is changed.

The following two measures are conceivable to avoid the image quality deterioration, and thus to obtain a desired print result.

The first measure is that: the information processing apparatus imposes the original printing data as desired by use of the printer driver again, and transmits the imposed printing data to the image forming apparatus to make print.

The second measure is that: the information processing apparatus transmits the original PDL document yet to be imposed and its print setting to the image forming apparatus; the image forming apparatus saves this PDL document and this print setting; and when reprinting the PDL document with scaling, the image forming apparatus make print by creating a dot image reflecting a scaling process from the PDL document yet to be imposed.

The first measure gives no consideration to an additional operation which a user is forced to perform. For this reason, the first measure does not solve the problem.

The second measure is capable of avoiding the image quality deterioration by use of a printing system/controlling method described, for example, in Japanese Patent Laid-Open Nos. 2000-315142 and 2000-298564.

Specifically, according to Japanese Patent Laid-Open Nos. 2000-315142 and 2000-298564, when an information processing apparatus transmits a PDL document and a job ticket including a print setting to an image forming apparatus, the image forming apparatus saves the PDL document as it remains in a PDL format, along with the job ticket, without developing the PDL document into a dot image. This makes it possible to develop the PDL document into a dot image which is imposed in a print format specified by a print request, when the print request arises. Accordingly, a desired print result can be obtained.

In the conventional example described in the above-mentioned patent gazettes, the PDL document can be printed with a print format different from that specified when the FDL document is transmitted from the information processing apparatus to the image forming apparatus.

However, printing of information excluded from the PDL document cannot be chosen. Specifically, a page not specified when the PDL document is created cannot be printed. In addition, monochromatic data generated when the PDL document is created cannot be converted into color data to make color print.

### SUMMARY OF THE INVENTION

An object of the present invention is to enable a printing job to be printed with a changed print format by a call-for print system in which: an image forming apparatus saves the printing job transmitted from an information processing apparatus, and prints the saved printing job.

The present invention for solving the above-described problem provides an information processing apparatus for generating a printing job to output data for printing. The apparatus comprises a job ticket generating component configured to generate a job ticket that specifies a print format and a processing method which are used to output the data for printing; a determination component configured to analyze the job ticket to determine the processing method; a data generating component configured to generate a printing data or a saving data depending upon a result of the determination, wherein the printing data is a data for print that reflects the print format specified by the job ticket and the saving data is a data for save that does not reflect the print format specified by the job ticket; and a job transmitting component configured to generate and transmit a printing job, wherein the job includes the job ticket and the printing data or includes the job ticket and the saving data.

The present invention for solving the above-described problem also provides an image forming apparatus. The apparatus comprises a receiving component configured to receive a printing job; a determination component configured to analyze a job ticket that specifies a print format and a processing method which are used to output data for printing to determine the processing method, wherein the received printing job includes the job ticket; and a processing component configured to generate a printing data that reflects the print format to output the data for printing and save a saving data that does not reflect the print format, when it is determined by the determination component that a specified processing method is a print and save process, based upon the saving data that does not reflect the print format and the job ticket, wherein the received printing job includes saving data.

The image forming apparatus further includes a format change determination component configured to determine whether or not the print format should be changed when the printing job is reprinted; a first printing component configured to convert the printing data into a dot image that is a data used for printing to print the resultant data, when the format change determination component determines that the print format should not be changed; and a second printing component configured to generate a third intermediate data from the saving data reflecting a changed print format and convert the third intermediate data into a dot image that is a data used for printing to print the resultant data, when the format change determination component determines that the print format should be changed and that the printing data is unusable.

According to the present invention, in a case where a printing job saved in the image forming apparatus after transmitted from the information processing apparatus to the image forming apparatus, is intended to be printed by the image forming apparatus at an arbitrary timing, the present invention makes it possible to print the printing job with a print format specified at the time of transmission being changed. Particularly, the present invention enables the printing job to be printed with regard to a print object page which is not specified when the printing job is transmitted. In addition, the present invention enables the printing job to be printed in color even if the printing job is introduced with a specification for monochrome.

Thereby, the present invention enhances user-friendliness and flexibility of process choice for a call-for print system in which: the print information is saved in the image forming apparatus without being printed immediately after received by the image forming apparatus; and the print information is outputted to be printed only after a user inputs a print instruction into the image forming apparatus through its console unit.

Further features of the present invention will become apparent from the following description of exemplary embodiments (with reference to the attached drawings).

### BRIEF DESCRIPTION OF THE DRAWINGS

FIG. 1 is a diagram showing a configuration of a network to which an information processing apparatus is connected so as to be capable of transmitting and receiving data to and from an image forming apparatus through the network;

FIG. 2 is a block diagram showing an internal configuration of a generally-used information processing apparatus;

FIG. 3 is a block diagram of an internal configuration of the image forming apparatus;

FIG. 4 is a diagram showing a program configuration of each of an information processing apparatus and an image forming apparatus which are used in an embodiment of the present invention;

FIG. 5 is a diagram showing a printing screen of an application;

FIG. 6 is a diagram showing a printer driver setup screen in the information processing apparatus;

FIG. 7 is a diagram showing a job ticket;

FIG. 8 is a diagram showing another job ticket;

FIG. 9 is a diagram showing an image display and a user command input unit in the image forming apparatus;

FIG. 10 is a diagram showing a printing screen in the image forming apparatus;

FIG. 11 is a diagram showing a print format changing screen in the image forming apparatus;

FIG. 12 is a diagram showing another print format changing screen in the image forming apparatus;

FIG. 13 is a diagram showing an overall sequence of a printing system;

FIG. 14 is a diagram showing a printing sequence of the image forming apparatus;

FIG. 15 is a diagram of a data configuration of a printing job;

FIG. 16 is another diagram showing the data configuration of the printing job;

FIG. 17 is yet another diagram showing the data configuration of the printing job;

FIG. 18 is a flowchart showing a flow in which the information processing apparatus generates the printing job;

FIG. 19 is a flowchart showing a flow in which the image forming apparatus processes the printing job;

FIG. 20 is a flowchart showing a flow in which the image forming apparatus performs a printing process;

FIG. 21 is a flowchart showing a flow in which determinations are made for reusing a display list;

FIG. 22 is another flowchart showing a flow in which the information processing apparatus generates the printing job;

FIG. 23 is another flowchart showing a flow in which the image forming apparatus processes the printing job;

FIG. 24 is a diagram showing another program configuration of each of the information processing apparatus and the image forming apparatus which are used in the embodiment of the present invention;

FIG. 25 is a diagram showing another printing sequence of the image forming apparatus;

FIG. 26 is a diagram showing a printing screen in the image forming apparatus;

FIG. 27 is a flowchart showing another flow in which the image forming apparatus performs a printing process;

FIG. 28 is a diagram showing another flow in which the information processing apparatus generates a printing job;

FIG. 29 is a diagram showing another printing screen of the application;

FIG. 30 is a diagram showing an example of components constituting a PDL;

FIG. 31 is a flowchart showing how the information processing apparatus performs a PDL generating process; and

FIG. 32 is a flowchart showing how the image forming apparatus performs a data converting process.

### DETAILED DESCRIPTION OF THE EMBODIMENTS

To begin with, definitions will be provided for characteristic terms used in this description.

### [Image Forming Apparatus]

An image forming apparatus is an apparatus used to print electronic data on a transfer material such as a sheet of paper. This term is synonymous with an image outputting apparatus, a printing apparatus and the like.

The term “image forming apparatus” is sometimes synonymous with a MFP (standing for a Multi-functional Peripheral) having multiple functions when the image forming apparatus has an image reading unit (scanner) and a printer.

The MFP includes: a printer function to print printing data formatted in a PDL or the like which is transmitted from an information processing apparatus; a function to copy an image which is read by an image reading unit; a function to transmit the image to another image processing apparatus through a facsimile machine or electronic mail; and a function to save an image and the like transmitted from an information processing apparatus in its auxiliary storage.

In this description, an apparatus having at least the above-described printer function and the above-described data saving function is termed as an “image forming apparatus.” The present invention is applicable to any other apparatus which includes an arbitrary function complementary to the above-described functions.

### [Information Processing Apparatus]

An Information processing apparatus is an operational aspect of a computer.

Information processing apparatuses are computers which are currently most-widely used in offices, homes and the like.

In this description, the term “information processing apparatus” is used to mean a computer. Nevertheless, the present invention is applicable to a system using a workstation or word processor as well.

MFP stands for Multi-functional Peripheral.

In this description, the term “MFP” means an image forming apparatus (composite machine) including multiple functions.

Specifically, the “MFP” includes: a function to print a printing job formatted in a PDL or the like which is transmitted from an information processing apparatus; a function to copy an image which is read by an image reading unit; a function to transmit the image to another information processing apparatus through a facsimile machine or an electronic mail; and a function to save an image and the like transmitted from a printer in its auxiliary storage.

### [PDL]

PDL stands for Page Description Language.

A PDL chiefly means a printer control code (language) used for a page printer.

A PDL is used to generate a page image.

Examples of a PDL include: a PDL used to print a simple character; and a PDL having an expanded function for rendering.

There are two types of page image: one is generated by an information processing apparatus, and the other is generated by an image forming apparatus. The present invention imposes no specific limitation on the page image.

### [Print Format]

A print format means various items and values which are set up before image data is printed by an image forming apparatus.

A print format is used to set up various items including: a quantity of copies; a page from which a printing should be started and a page through which the printing should be ended; an output size; a color printing mode; a monochrome printing mode; font information; a stapling mode; a punching mode; a single-sided printing mode; double-sided printing mode; where sheets are bound; a layout; and the like. The output size can be set up for each page.

### [Layout Setup]

This description defines the layout as being set up as a kind of print format.

Specifically, the layout setup is a setup for an imposing process of arranging multiple pages in a single sheet of paper.

For instance, “2 pages on sheet” means an imposing process of arranging data covered by two pages in a single sheet of paper, and “4 pages on sheet” means an imposing process of arranging data covered by four pages in a single sheet of paper.

In a case where two-page original in A4 size is outputted in A4 size with a layout setup of “2 pages on sheet,” the two-page original is reduced from A4 size to A5 size, and thus data covered by the two-page original reduced to A5 size is printed out on a single sheet of paper in A4 size.

### [Application Data]

Application data is data which is included in an arbitrary data processing application, and which is capable of be used by an information processing apparatus as a computer and the like. Particularly, the application data is original data which may be used for a printing.

In the case of widely-used application such as Microsoft® Word® and Microsoft® Excel®, data whose document name includes an extension “doc” or “xls” is application data.

### [Printer Driver]

A printer driver is a software module which is capable of being used by an information processing apparatus or the like, and which is used to convert application data into printing data on a basis of a rendering command from an arbitrary data processing application.

An arbitrary data processing application means an application which is used to edit, display and calculate data. Microsoft® Word®, Microsoft® Excel® and the like are widely known as a data processing application.

A printer driver generates a printing job such as PDL data by causing the printing job to reflect setup items which are set up by use of a printing function of an arbitrary application or a print format specifying function provided by a printer driver.

A printing job generated by a printer driver is transmitted to an image forming apparatus, and is converted into a dot image for a print image in the image forming apparatus. Thus, the printing job is printed by the image forming apparatus.

In recent years, there have been printer drivers of a type which not only causes a printing job to be printed by an image forming apparatus, but also causes the printing job to be saved in an auxiliary storage in the image forming apparatus, as well. In addition, there have been image forming apparatuses of a type which not only prints a printing job, but also saves the printing job in its auxiliary storage, as well.

### [Dot Image]

A dot image is image data formatted to be capable of being printed by a print engine of an image forming apparatus.

In a printing process according to the present invention, an image forming apparatus develops printing data formatted in a PDL or the like which is received from an information processing apparatus into a dot image depending on a characteristic of the image forming apparatus, and uses the dot image obtained by this expansion in order to print the printing data.

### [Job Ticket]

A job ticket is an information file in which a print format desired by a user is described.

A format used for a job ticket may be text-based. Otherwise, a job ticket may be binary-formatted or formatted in any other way.

A job ticket may be treated as a separate file. Otherwise, a job ticket may be formatted to be embedded in printing data formatted in a PDL or the like.

### [Printing Job]

A printing job is job printing data which is transmitted from an information processing apparatus to an image forming apparatus.

A printing job is configured by arbitrarily combining a job ticket, vector data, intermediate data and PDL data.

### [Vector Data]

Vector data is data formatted to form a graphics image from print object data included in application data by use of geometric graphic elements such points, straight lines, circles, lines, polygons and Bezier curves.

A printer driver converts application data into vector data, and subsequently transmits the vector data to an image forming apparatus. The image forming apparatus converts the vector data into a display list as intermediate data, and subsequently converts the display list into a dot image, thereby performing printing. Otherwise, a printer driver converts application data into vector data, and thus generates a display list from the vector data, subsequently transmitting the display list to an image forming apparatus. The image forming apparatus converts the display list into a dot image, thereby performing printing.

Furthermore, in a case where application data includes photographic data or the like, this description refers to such application data as part of vector data as well. Moreover, this description refers to font information (including a font identifier and a font size) as vector data as well.

### [Display List]

A display list is an intermediate code for developing the vector data into a dot image.

A display list includes rendering information, such as arrangement information and layout information, which is used to actually print objects (including graphics, photographs and fonts) on a sheet of paper.

In a case where data saved in an image forming apparatus is intended to be printed by the image forming apparatus, the image forming apparatus can start the printing operation by generating a dot image from the display list as an intermediate data more quickly than by converting the data into a dot image on a basis of the vector data.

### [Print Engine]

A print engine is a control program for driving hardware and software, which is used when an image forming apparatus prints electronic data on a sheet of paper.

### [Printer Object]

A printer object is a printer driver used by an information processing apparatus for each image forming apparatus.

An actual entity of a printer object is a printer object.

### Embodiment 1

As described below, this embodiment is carried out as a control method which is performed to change a print format from one to another in a case where: a printing job is transmitted from an information processing apparatus to an image forming apparatus; the image forming apparatus saves the printing job; and a user prints the printing job having been saved in the image forming apparatus.

Particularly, the changing of the print format to a current of another is characterized in that: a page specified to be printed is capable of being changed to another; a page layout for a printing is capable of being changed to another; a color printing mode is capable of being changed to a monochromatic printing mode; and a monochromatic printing mode is capable of being changed to a color printing mode.

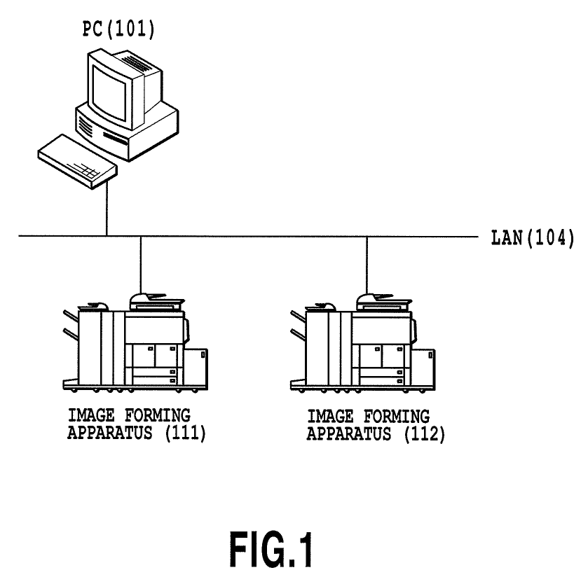

FIG. 1 shows an example of a network configuration including: at least one information processing apparatus capable of transmitting and receiving data to and from an image forming apparatus through the network; and at least one image forming apparatus.

As shown in FIG. 1, an information processing apparatus (personal computer) 101 and image forming apparatuses (multi-functional peripherals) 111, 112 are capable of being connected to the network.

The information processing apparatus 101, the image forming apparatus 111 and the image forming apparatus 112 are connected together through a LAN (standing for Local Area Network) 104 as the network.

The image forming apparatus 112 is not essential for this embodiment. In this embodiment, the information processing apparatus 101 and the image forming apparatus 111 are connected to each other through the network 104. Instead, this embodiment is also applicable to a configuration in which the information processing apparatus 101 and the image forming apparatus 111 are connected to each other through a parallel cable, serial cable, USB cable or the like. In addition, the network connection configuration is not limited to the LAN environment. This embodiment is applicable to a configuration in which the information processing apparatus 101 and the image forming apparatus 111 are connected to each other through an Internet environment.

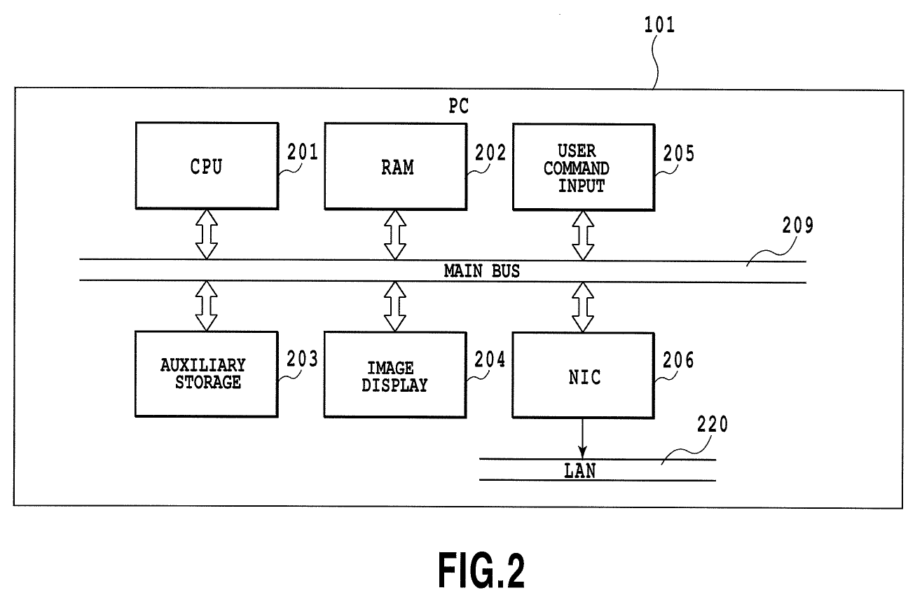

FIG. 2 shows an example of an internal configuration of a generally-used information processing apparatus. The inner configuration of the information processing apparatus 101 shown in FIG. 1 may be the internal configuration shown in FIG. 2.

A CPU (standing for Central Processing Unit) 201 uses a RAM (standing for Random Access Memory) 202 as a work area, and thus controls the information processing apparatus 101. In this embodiment, control programs are stored in an auxiliary storage 203 (including a hard disc, a Floppy® and a CD-ROM (standing for Compact Disc-Read Only Memory) and the like).

For the purpose of informing a user of messages, an image display (specifically, a CRT (standing for Cathode Ray Tube) display, or a liquid crystal display) 204 is included in the information processing apparatus 101. In order for a user's commands to be inputted into the information processing apparatus 101, a user command inputting unit (specifically, a mouse, a key board and the like) 205 is included in the information processing apparatus 101.

In order to transmit and receive data to and from another network apparatus through the LAN 220, the information processing apparatus 101 includes a network interface card (NIC) 206. A LAN 220 is the same as the LAN 104 shown in FIG. 1. Reference Numeral 209 denotes a main bus.

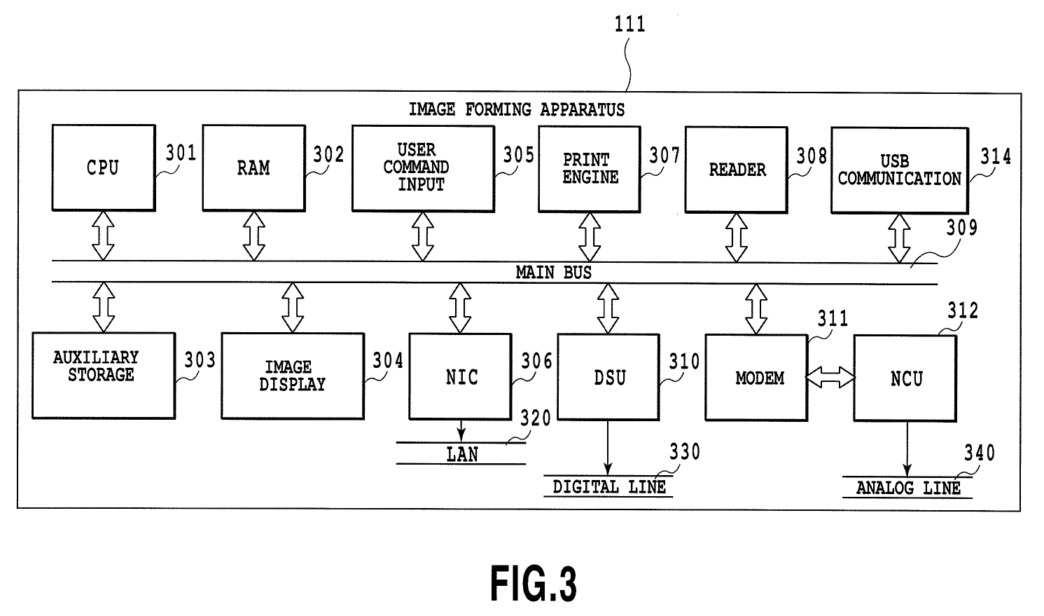

FIG. 3 shows an example of an internal configuration of the image forming apparatus 111.

In FIG. 3, a CPU 301 interprets a printing job received from the information processing apparatus 101, and performs a print control and the like.

Data is temporarily stored in a RAM 302 as a work area for the CPU 301.

In some cases, data is temporarily stored in an auxiliary storage (such as a hard disc, a CD-ROM and the like) 303, and the auxiliary storage 303 is used instead of the RAM 302 on a basis of a determination made by the CPU 301.

An image display 304 such as a touch panel may be used to indicate a condition of a printing apparatus, an error message and the like.

A user command inputting unit (such as a touch panel) 305 is included in the image forming apparatus 111 in order for a user to operate the user command inputting unit 305 for inputting log-in information, specifying document data which is desired by the user, and for other purposes.

In order to bilaterally communicate data with another network apparatus through a LAN 320, the image forming apparatus 111 includes an NIC 306. The LAN 320 is the same as the LAN 104 shown in FIG. 1.

Each of the image display 304 and the user command inputting unit 305 may be a module, such as a touch panel, which is constructed as a unit.

In order to actually output a printing job transmitted from the information processing apparatus 101 and like on a sheet of paper, the image forming apparatus 111 includes a print engine 307.

In order to generate electronic data represented with a monochrome binary value or a color multiple-value by reading a sheet original placed on an original stage, the image forming apparatus 111 includes a reader (scanner) 308.

In order to transmit and receive data through a digital line 330 by connecting the image forming apparatus 111 to the digital line 330, a DSU (standing for Digital Service Unit) 310 is included in the image forming apparatus 111. A NCU (standing for Network Control Unit) 312 is including in the image forming apparatus 111 in order that the NCU 312 can do things such as opening and closing an analog line 340, checking an incoming and outgoing connection to the analog line 340, as well as transmitting and receiving image data (in analog) through the analog line 340 when the image forming apparatus 111 is connected to the analog line 340.

A modem 311 modulates data for transmission, and demodulates received data. A USB (standing for Universal Serial Bus) communication unit 314 transmits data to, and receives data from, an external information terminal device by use of a USB.

None of the reader 308, the DSU 310, the modem 311, the NCU 312, the digital line 330 or the analog line 340 is essential for this embodiment.

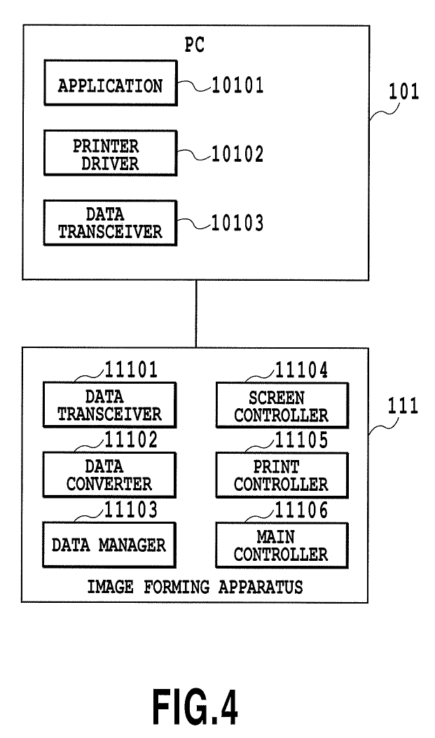

FIG. 4 shows program configurations used for this embodiment.

Like Microsoft® Word® and Microsoft® Excel®, programs used in the information processing apparatus 101 include an arbitrary application 10101 having a printing function, a printer driver 10102 and a data transmitter/receiver 10103. This program configuration is operated on a basis of determination made by the CPU 201 shown in FIG. 2.

Upon receipt of a print instruction from the arbitrary application 10101, the printer driver 10102 converts the format of application data into a format with which the image forming apparatus 111 is capable of interpreting application data. On a basis of an instruction from the printer driver 10102, the data transmitter/receiver 10103 is used when the information processing apparatus 101 transmits a printing job to the image forming apparatus 111 through the NIC 206.

Programs used in the image forming apparatus 111 include a data transmitter/receiver 11101, a data converter 11102, a data manager 11103, a screen controller 11104, a print controller 11105 and a main controller 11106. This program configuration is operated on a basis of determination made by the CPU 301 shown in FIG. 3.

The main controller 11106 is a program module for controlling the image forming apparatus 111 according to this embodiment overall.

The data transmitter/receiver 11101 receives the printing job from the information processing apparatus 101 through the NIC 306.

On a basis of an instruction from the main controller 11106, the data converter 11102 converts the format of the printing job, received from the information processing apparatus 101, into a format with which the print engine 307 is capable of performing a printing process.

On a basis of an instruction from the main controller 11106, the print controller 11105 performs a print control on the data so formatted as to be printable, which is generated by the data converter 11102, by use of the printer driver 307.

On a basis of an instruction from the main controller 11106, the data manager 11103 is used when the data is saved in the auxiliary storage 303, and when the data saved in the auxiliary storage 303 is loaded in the RAM 302 or the like.

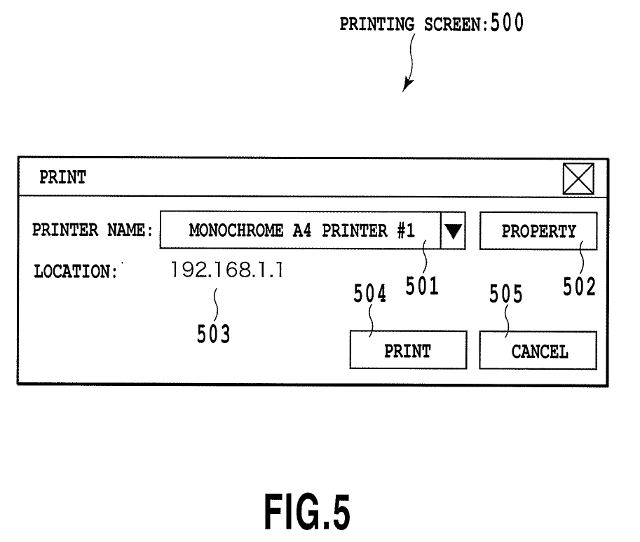

FIG. 5 shows an example of a screen concerning a printing function included in the arbitrary application 10101 in the information processing apparatus 101.

A printing screen 500 includes a printer object selecting section 501, a property button 502 for specifying a print format of the printer object, a network address displaying section 503, a print button 504 and a cancel button 505.

In a case where multiple printer objects are capable of being used in the information processing apparatus 101, a printer object to be used for printing is capable of being chosen by use of the printer object selecting section 501.

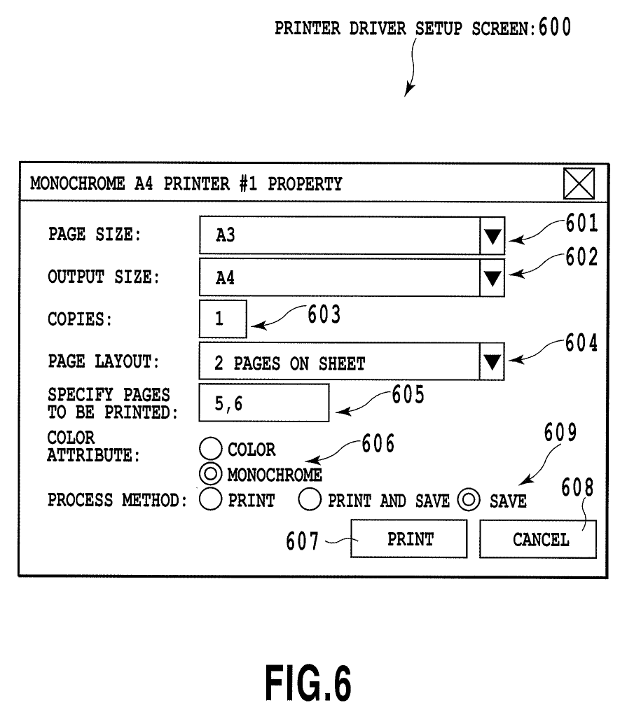

Once the property button 502 is pressed, the arbitrary application 10101 receives information that the property button 502 is pressed, and thus causes a printer driver setup screen 600 shown in FIG. 6 to be displayed on the image display 204.

Once the print button 504 is pressed, the arbitrary application 10101 generates a printing job by use of the printer driver 10102, and subsequently transmits the printing job to a desired image forming apparatus via the data transmitter/receiver 10103.

Once the cancel button 505 is pressed, the arbitrary application 10101 cancels the printing process.

FIG. 6 shows an example of the printer driver setup screen which is displayed by the image display 204 when the property button 502 shown in FIG. 5 is pressed. In this embodiment, let us assume that this printer driver setup screen is used when a print format is specified.

A printer driver setup screen 600 includes an original size specifying section 601, an output sheet size specifying section 602, a copy quantity specifying section 603, a page layout specifying section 604, a page-to-be-printed specifying section 605, a print color specifying section 606, a print button 607, a cancel button 608 and a processing method specifying section 609.

A size is specified for the first page of the application data by use of the original size specifying section 601. The original size specifying section 601 may be so configured that the application informs the printer driver of the specified size, or may be so configured that the application does not inform the printer driver of the specified size. In this embodiment, one can be chosen from two sizes including “A4” and “A3.” In addition, the default original size is “A4.”

The size of an output sheet on which the application data is printed is specified by use of the output sheet size specifying section 602. In this embodiment, one can be chosen from three sizes including “the same as the original size (s),” and “A4” and “A3.”

Let us assume that, for instance, there is application data whose first page is in A4 size, whose second page is in A3 size, and whose third page is in A4 size.

In this case, the image forming apparatus 111 prints the first page of the application data in A4 size, the second page thereof in A3 size, and the third page thereof in A4 size, when the output sheet sizes are specified as “the same as the original size(s).”

When the output sheet sizes are instead specified as “A4,” then the image forming apparatus 111 prints all of the three pages of the application data in A4 size. The default output sheet size is “the same as the original size(s).” The printer driver 10102 generates vector data reflecting the original size (s) without reflecting the sheet size (s) specified by use of the output sheet size specifying section 602 on the vector data.

The quantity of copies of the application data is specified by use of the copy quantity specifying section 603.

A layout is set up by use of the page layout specifying section 604. In this embodiment, one can be chosen from two layouts including “not specified” and “2 pages on sheet.” When “not specified” is chosen, the image forming apparatus 111 prints the application data without setting up any layout. The default layout setup is “not specified.”

Pages of the application data to be printed are specified by use of the printed-page specifying section 605. The default printed page is blank (not specified). The printer driver 10102 generates the vector data without reflecting the layout setup specified by use of the page layout specifying section 604 on the vector data.

Whether the application data should be printed in color or in monochrome is specified by use of the print color specifying section 606. In a case where the image forming apparatus 111 includes a color printing function, one can be chosen from two modes including a color printing mode and a monochrome printing mode.

The default print color is “monochrome.” In a case where the image forming apparatus 111 includes no color printing function, only the monochrome printing mode can be specified. The print color specifying section 606 shown in FIG. 6 is that used for the image forming apparatus 111 including no color printing function. The print color specifying section 606 is disable, and the monochrome printing mode is always chosen. Even if “monochrome” is specified by use of the print color specifying section 606, the printer driver 10102 generates the vector data with a “color” attribute as long as the application data is polychrome.

A processing method to be carried out by the image forming apparatus 111 is specified by use of the processing method specifying section 609. In this embodiment, one can be chosen from three processing methods including “print,” “print and save” and “save.”

Once the print button 607 is pressed, the printer driver 10102 generates a job ticket 700 reflecting a print format specified by use of the printer driver setup screen 600, and closes the printer driver setup screen 600 which has been displayed on the image display 204 up until now.

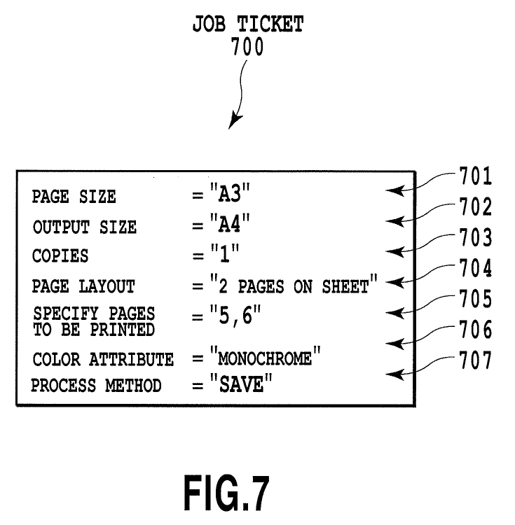

FIG. 7 shows an example of a job ticket generated by the printer driver.

If the print button 504 is pressed on the printing screen 500 at the same timing as the job ticket 700 is generated, the printer driver 10102 generates the vector data, and adds setup values described in the generated job ticket 700 to the vector data, thereby generating the printing job.

Subsequently, the printer driver 10102 transmits the printing job in which the contents of the job ticket are embedded to the image forming apparatus 111 through the data transmitter/receiver 10103.

Once the cancel button 608 is pressed on the printer driver setup screen 600, the printer driver 10102 closes the printer driver setup screen 600 which has been displayed on the image display 204 up until now without generating any job ticket.

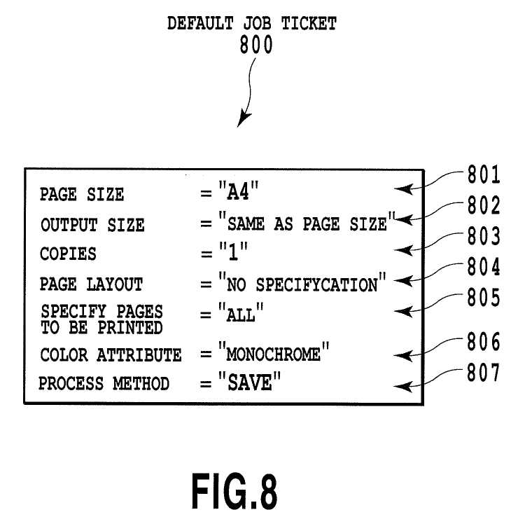

In this embodiment, if the print button 504 on the printing screen 500 is pressed while no job ticket is generated, another job ticket is generated in a default print format. FIG. 8 shows an example of a default job ticket generated by the printer driver.

As described above, the setup values specified by use of the printer driver setup screen 600 are described in the job ticket 700 shown in FIG. 7.

As described above, the default values in the print format are described in a job ticket 800 shown in FIG. 8.

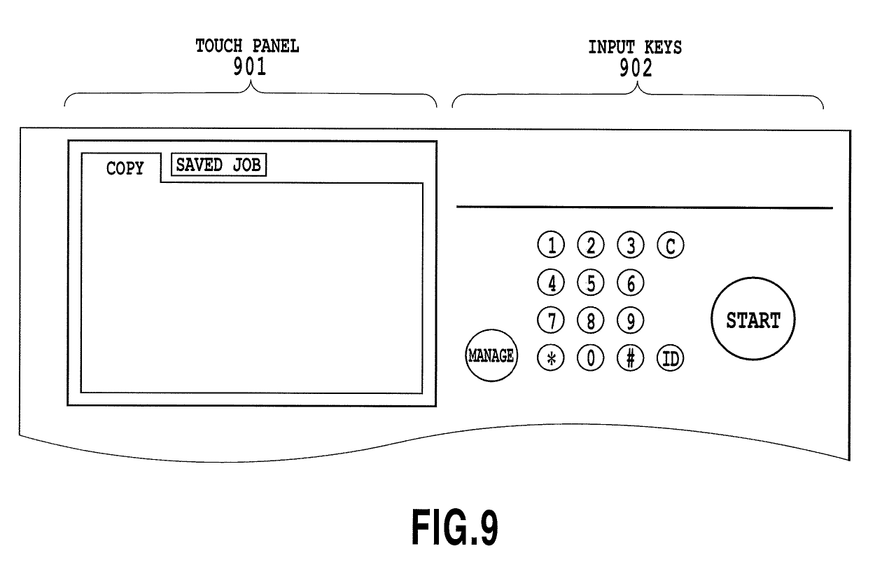

FIG. 9 shows how the image display 304 and the user command inputting unit 305 included in the image forming apparatus 111 are implemented. The display and unit shown in FIG. 9 include a touch panel 901 and input keys 902.

The touch panel 901 displays the functions which the image forming apparatus 111 includes. The touch panel 901 is used in order that the image forming apparatus 111 can receive an instruction desired by a user when the user presses a button or the like. In this embodiment, the touch panel 901 is capable of switching the functions of the image forming apparatus 111 when the user uses a tab page.

The input keys 902 are used together with the touch panel 901. The input keys 902 are used when an instruction of the user is transmitted to the image forming apparatus 111.

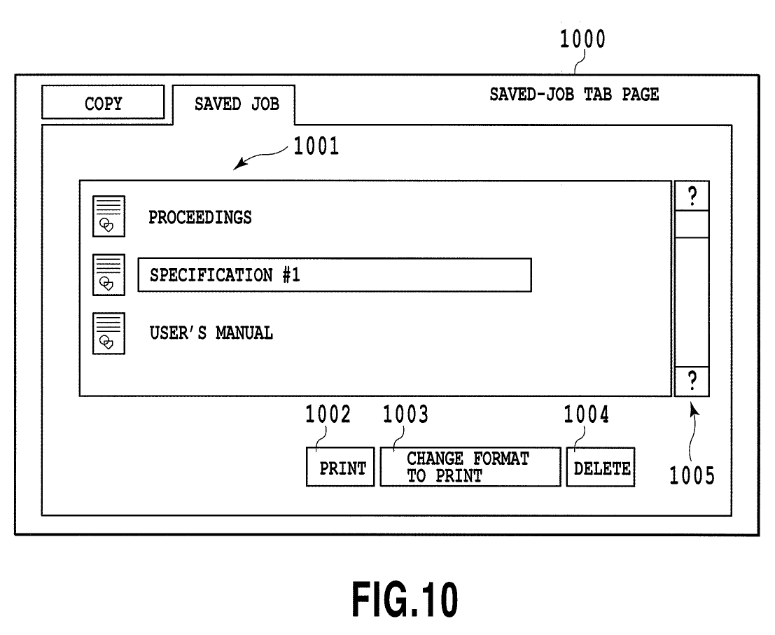

FIG. 10 shows an example of a screen which is displayed in a case where a “saved jobs” tab page is chosen by use of the touch panel 901 shown in FIG. 9.

A “saved jobs” tab page 1000 includes a printing-job displaying section 1001, a “print” button 1002, a “change format to print” button 1003, a “delete” button 1004, and a scroll button 1005.

Jobs for printing which have been transmitted from the information processing apparatus 101 are displayed in a list on the printing-job displaying section 1001.

Once an arbitrary job is chosen by the user, the color in which the arbitrary job is displayed is changed to a different color. Thereby, the image forming apparatus 111 enables the printing job as a process object to be identified.

Once the “print” button 1002 is pressed, the printing job chosen by use of the printing-job displaying section 1001 is printed by use of the data converter 11102 and the print controller 11105.

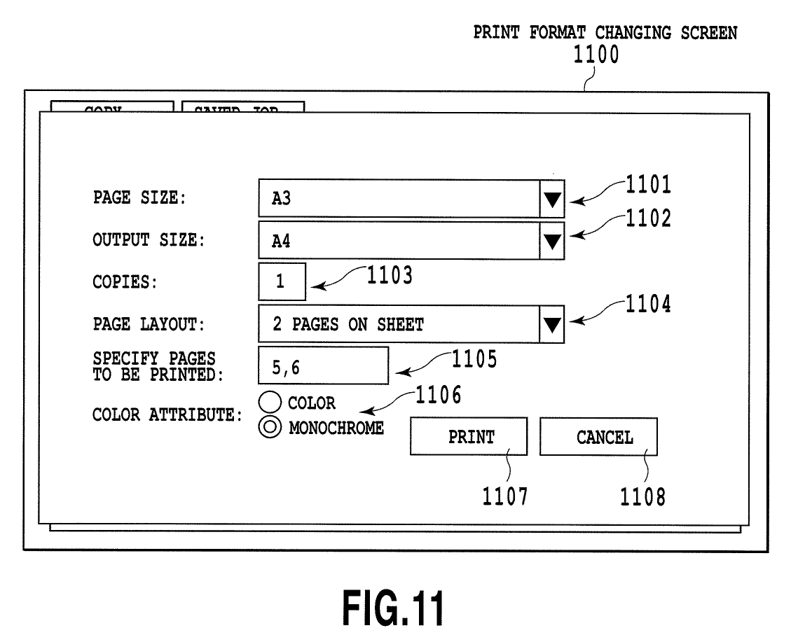

The “change format to print” button 1003 is used in a case where the printing job as the process object is printed by changing the print format specified by use of the printer driver setup screen 600 in the information processing apparatus 101 to a different print format. Once the “change format to print” button 1003 is pressed, a print format changing screen 1100 (shown in FIG. 11) is displayed.

Once the “delete” button 1004 is pressed, the printing job chosen by use of the printing-job displaying section 1001 is deleted. Once the scroll button 1005 is pressed, the list of jobs for printing is scrolled in a case where there are jobs for printing which are not displayed on the printing-job displaying section 1001 at a time.

FIG. 11 shows an example of a screen which is displayed in the case where the “change format to print” button 1003 shown in FIG. 10 is pressed.

Once the “change format to print” button 1003 is pressed, the main controller 11106 in the image forming apparatus 111 obtains the printing job through the data manager 11103, and identifies the job ticket included in the printing job. Thus, the print format described in the job ticket is reflected on the print format changing screen 1100.

The print format changing screen 1100 includes an original size specifying section 1101, an output sheet size specifying section 1102, a number-of-copies specifying section 1103, a page layout specifying section 1104, a page-to-be-printed specifying section 1105, a print color specifying section 1106, a print button 1107, and a cancel button 1108.

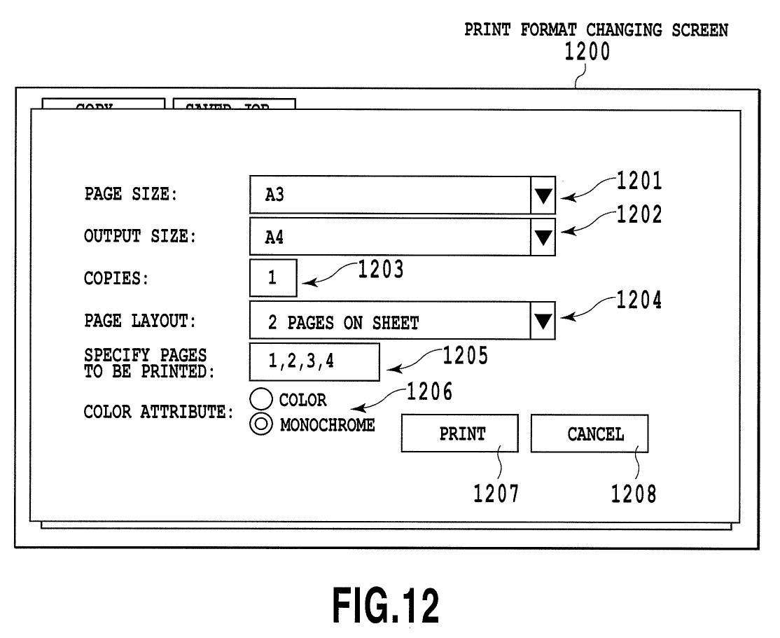

FIG. 12 shows an example of a screen which is displayed in a case where a print format is changed by use of the print format changing screen 1100. What makes a print format changing screen 1200 different from the print format changing screen 1100 is a page-to-be-printed specifying section 1205.

Once the print button 1107 or a print button 1207 is pressed, the main controller 11106 generates a display list from the vector data included in the printing job reflecting the specified print format with the data converter 11102. Thus, the main controller 11106 generates a dot image from the generated display list, and causes the print controller 11105 to perform a desired printing process by use of the print engine 307.

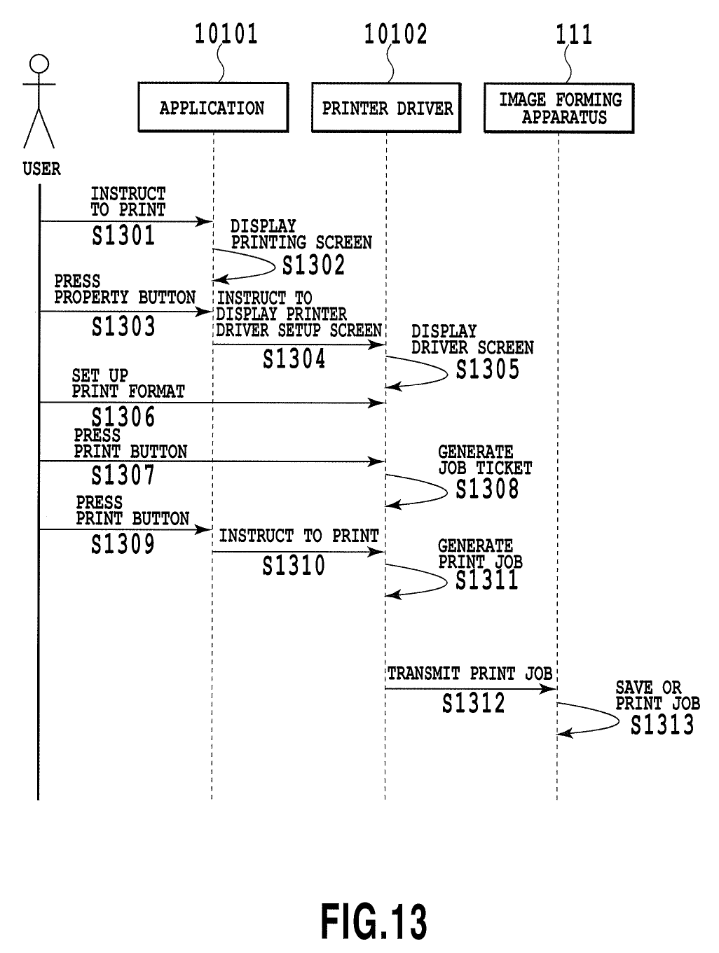

FIG. 13 shows a sequence in which: the information processing apparatus 101 generates a printing job, and subsequently transmits the printing job to the image forming apparatus 111; and the image forming apparatus 111 thus receives the printing job, and thereafter saves the received printing job in the auxiliary storage 303.

Once a user instructs the arbitrary application 10101 to print the application data in the information processing apparatus 101 (in step S1301), the arbitrary application 10101 displays the printing screen 500 shown in FIG. 5 on the image display 204 (in step S1302).

Once the user presses the property button 502 in the printing screen 500 (in step S1303), the arbitrary application 10101 instructs the printer driver 10102 to display the printer driver setup screen 600 (in step S1304).

The printer driver 10102 displays the printer driver setup screen 600 on the image display 204 (in step S1305), and thus receives a print format setup from the user (in step S1306).

Once the user presses the print button 607 on the printer driver setup screen 600 (in step S1307), the printer driver 10102 generates a job ticket reflecting the setup values specified by use of the printer driver setup screen 600 (in step S1308).

Once the user presses the print button 504 on the printing screen 500 (in step S1309), the arbitrary application 10101 instructs to print to the printer driver 10102 (in step S1310). Upon receipt of the print instruction, the printer driver 10102 generates a printing job (in step S1311), and embeds the setup values described in the generated job ticket 700 in the printing job. Descriptions will be provided for the structure of this printing job later.

Subsequently, the printer driver 10102 transmits the printing job, in which the setups reflected on the job ticket are embedded, to the image forming apparatus 111 through the data transmitter/receiver 10103 (in step S1312). Upon receipt of the printing job, the image forming apparatus 111 saves or prints the printing job (in step S1313).

Detailed descriptions will be later provided for the printing-job generating process carried out in step S1311 and the process concerning the printing job carried out in step S1313.

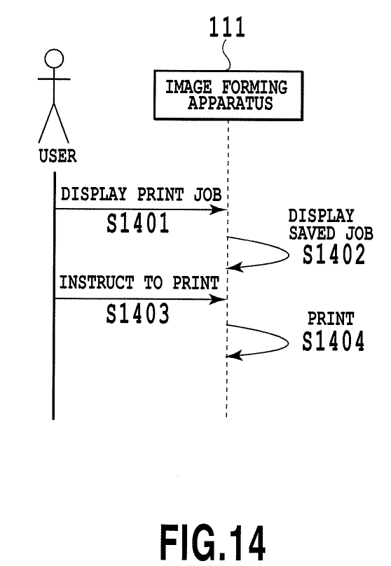

FIG. 14 shows an example of a process sequence in which: saved jobs for printing are displayed on the image display 304 in the image forming apparatus 111; and subsequently a desired printing job is printed.

Once the user chooses the “saved job” tab page on the image display 304 in the image forming apparatus 111 (in step S1401), the image forming apparatus 111 displays the saved jobs for printing on the printing-job displaying section 1001 (in step S1402).

Once the “print” button 1002 or the “change format to print” button 1003 is pressed after an arbitrary printing job is chosen on the printing-job displaying section 1001, the print instruction is given (in step S1403).

The main controller 11106 in the image forming apparatus 111 prints the chosen printing job by use of the print controller 11105 (in step S1404).

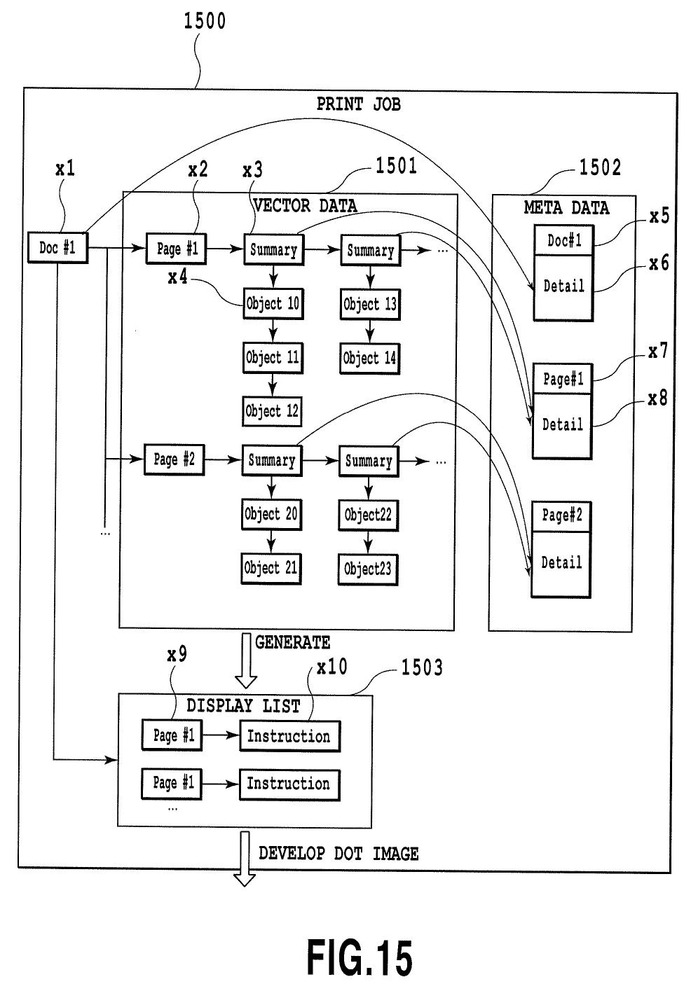

FIG. 15 shows a data structure of the printing job.

A saved document is data covered by multiple pages. The saved document is configured chiefly of vector data 1501, meta data 1502 and a display list 1503. The saved document begins with a document header x1, and has a hierarchical structure.

The vector data 1501 is configured of page headers x2, sets of summary information x3, and objects x4.

The meta data 1502 is configured of document information x5, document detailed information x6, sets of page information x7 and sets of page detailed information x8.

The display list 1503 is configured to page headers x9 and instructions x10 for rendering and expansion.

A storage location of the vector data and a storage location of the display list are described in the document header x1. For this reason, the vector data and the display list are associated with each other by the document header x1.

Layout information as rendering information on the size and orientation of each page is described in each page header x2. Each object x4 is linked with render data on a line, a polygon, a Bezier curve or the like on a one-to-one basis. A group consisting of multiple objects is associated with each set of summary information x3. Each set of summary information x3 represents characteristics of the corresponding multiple objects as a group. Information constituting a basis of a corresponding image area is described in each set of summary information x3. In addition, as render objects x4, image objects may be linked with each set of summary information x3 in some cases.

The meta data 1502 is additional information related to no rendering process. Document information is described in an area allocated for the document information x5. The document information includes, for instance, a document sender identifier, a document name, as well as data and time when the document was sent. Document detailed information is described in an area allocated for the document detailed information x6. The document detailed information includes, for instance, a print format of the document as a whole.

In this embodiment, information described in the above-described job ticket is described in the document detailed information x6. The meta data 1502 is threaded to the document head x1. This thread makes it possible to find the document detailed information x6 from the document header x1.

Page information is described in an area allocated for each sets of page information x7. For instance, the page information includes information on whether the meta data 1502 has been created from image mode data or from PDL data including character objects.

Security-related attribute information and a character string (character code string) generated as additional information are described in each set of page detailed information x8. The meta data 1502 is threaded to each set of summary information x3 in the vector data 1501. This thread makes it possible to find each set of page detailed information x8 from its corresponding set of summary information x3.

The display list 1503 is an intermediate code used for a renderer to carry out bitmap expansion. A management table of rendering information (instructions) on rendering in a corresponding page and the like are described in each page header x9. Each instruction x10 is configured of rendering information on which the resolution depends.

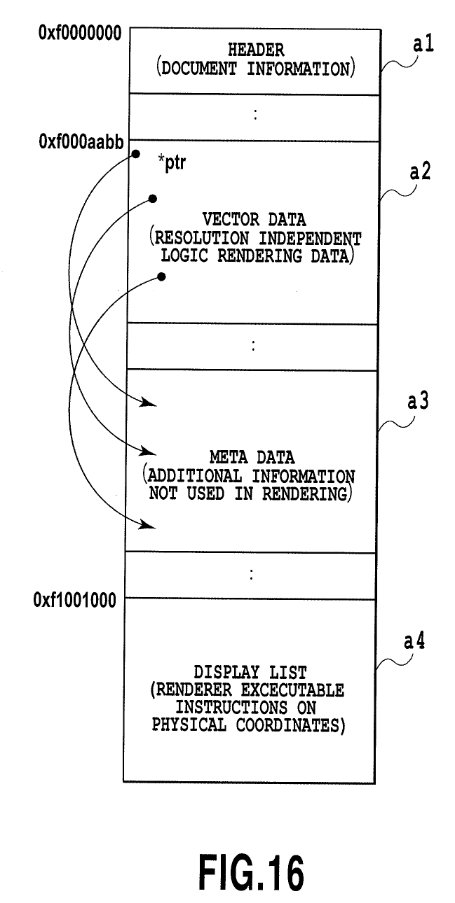

FIG. 16 is a diagram showing how the data structure described by use of FIG. 15 is arranged on memory. For the electronic document data, as shown in FIG. 16, the vector data area, the meta data area, and the display list area are arranged in their respective arbitrary addresses on the memory.

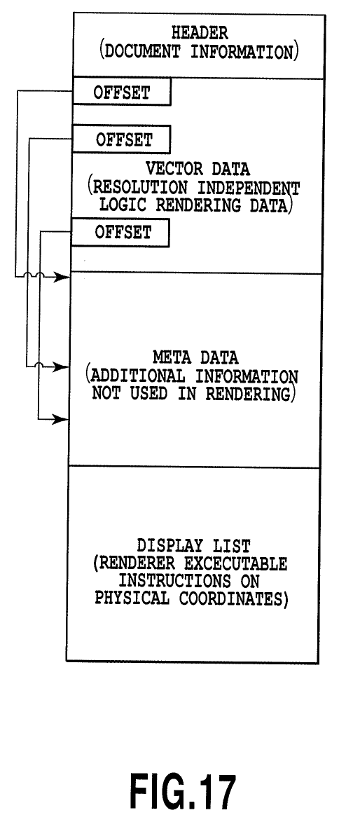

FIG. 17 is a diagram showing how the data structure described by use of FIG. 15 is arranged on a file. For the electronic document data, as shown in FIG. 17, the vector data area, the meta data area and display list area are serialized in a single file.

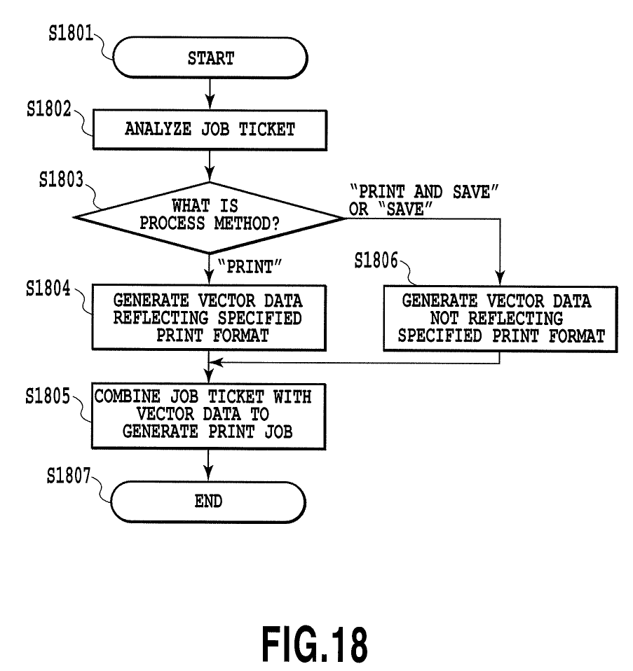

FIG. 18 shows an example of a detailed flow in which the printing job is generated in step S1311 (FIG. 13).

Upon receipt of a print instruction from the arbitrary application 10101, the printer driver 10102 analyzes the contents of the job ticket 700 or the job ticket 800 which has been stored (in step S1802).

The printer driver 10102 analyzes the job ticket, and thereby analyzes the processing method (in step S1803).

If the result of the analysis is that the processing method described in the job ticket is “print,” the printer driver 10102 generates vector data reflecting the print format specified in the job ticket (in step S1804).

In a case where, for instance, the output sheet size is specified as “A4” and the page layout is specified as “2 pages on sheet,” the printer driver 10102 generates vector data 1501 in A5 size on the basis of the application data, and describes in the page header (x2) that the rendering should be carried out with the “2 pages on sheet” page layout. In a case where the pages to be printed are specified as “5, 6,” the printer driver 10102 generates only the 5th and 6th pages of the application data as the vector data 1501. In a case where the color attribute is specified as “monochrome,” the printer driver 10102 generates the vector data 1501 with the “monochrome” specification even if the application data is polychrome.

The generated vector data which reflects the print format in this manner is of a type which makes the print format unsuitable to be changed by the image forming apparatus 111. Hereinafter, the vector data reflecting the print format in this manner will be referred to as “first vector data.”

After generating the printing job in step S1804, the printer driver 10102 additionally describes the print format, which is described in the job ticket, in the (x6) part of the meta data 1502 in the printing job (in step S1805), and subsequently ends the printing-job generating process (in step S1807).

In contrast, if the result of the analysis carried out in step S1802 is that the processing method described in the job ticket is “print and save” or that the processing method described in the job ticket is “save,” the printer driver 10102 generates vector data which allows the image forming apparatus to later change the print format easily with the print format specified in the job ticket being not reflected on the vector data (in step S1806).

Even in a case where, for instance, the output sheet size is specified as “A4” and the page layout is specified as “2 pages on sheet,” the printer driver 10102 generates vector data 1501 reflecting the size of each page of the application data. Even in a case where the pages to be printed are specified as “5, 6,” the printer driver 10102 generates the vector data 1501 covering all the pages of the application data. Even if the color attribute is specified as “monochrome,” the printer driver 10102 generates the vector data 1501 reflecting the color attribute of the application data.

Hereinafter, the vector data which is generated without reflecting any print format as described above, and which allows the image forming apparatus to later change the print format easily, will be referred to as “second vector data.”

After generating the vector data in step S1806, the printer driver 10102 performs the process to be carried out in step S1805, and subsequently ends the printing-job generating process (in step S1807).

Thereafter, the printing job generated in step S1807 is transmitted from the information processing apparatus 101 to the image forming apparatus 111.

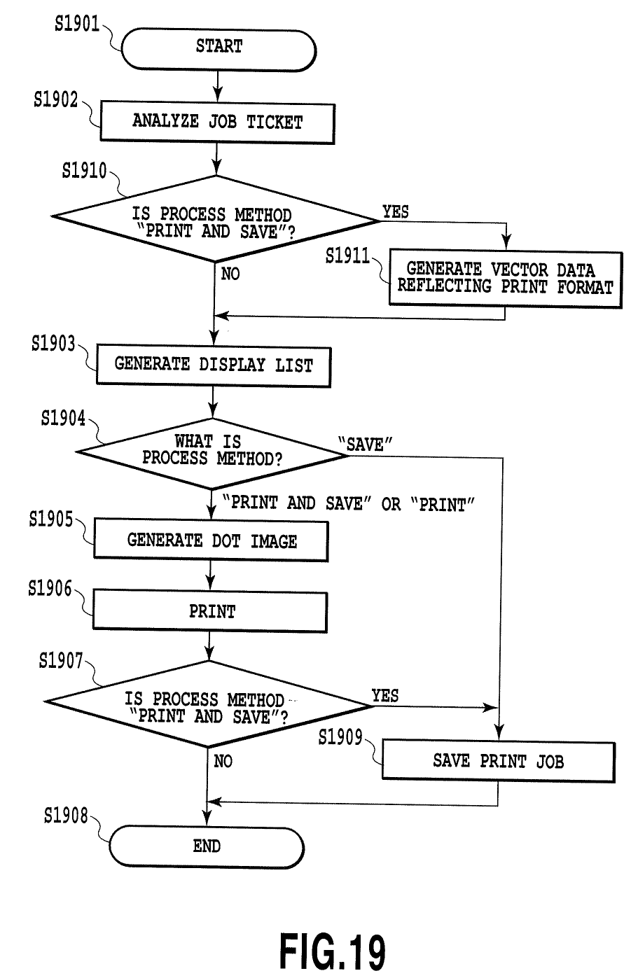

FIG. 19 shows an example of a detailed flow in which the image forming apparatus 111 processes the printing job (in step S1313 in FIG. 13).

Upon receipt of the printing job from the printer driver 10102 through the data transmitter/receiver 10103, the image forming apparatus 111 analyzes the print format which is described as the document detailed information x6 in the meta data 1502 of the printing job (in step S1902). At this time, if the image forming apparatus 111 determines in step S1910 that the processing method is “print and save,” the image forming apparatus 111 generates first vector data reflecting the print format from second vector data on which the print format received from the information processing apparatus 101 is not reflected (in step S1911). Subsequently, the image forming apparatus 111 generates intermediate data, that is, a display list 1503 on the basis of the vector data 1501 in the printing job (in step S1903).

Thereafter, if the image forming apparatus 111 determines in step S1904 that the processing method is “save,” the image forming apparatus 111 stores a printing job in the auxiliary storage 303 (in step S1909), and then ends the process (in step S1908). In this respect, the printing job is accompanied by the display list (first intermediate data) which does not reflect the print format specified in the job ticket, and which is generated from the generated second vector data.

In contrast, if the image forming apparatus 111 determines in step S1904 that the processing method is the data converter 11102 converts the display list 1503 into a dot image (in step S1905). In this respect, the display list 1503 is the first intermediate data which is generated in step S1903 from the vector data generated in step S1911.

After the data converter 11102 generates the dot image, the print controller 11105 prints the dot image by use of the print engine 307 (in step S1906).

After the printing is completed, the image forming apparatus 111 judges what the processing method is (in step S1907). If the image forming apparatus 111 determines that the processing method is “print,” the image forming apparatus ends the process with doing anything else (in step S1908). In contrast, if the image forming apparatus 111 determines that the processing method is “print and save,” the image forming apparatus 111 saves second intermediate data which is generated in step S1903 by use of the second vector data not reflecting the print format received from the information processing apparatus 101 (in step S1909), and ends the process (in step S1908).

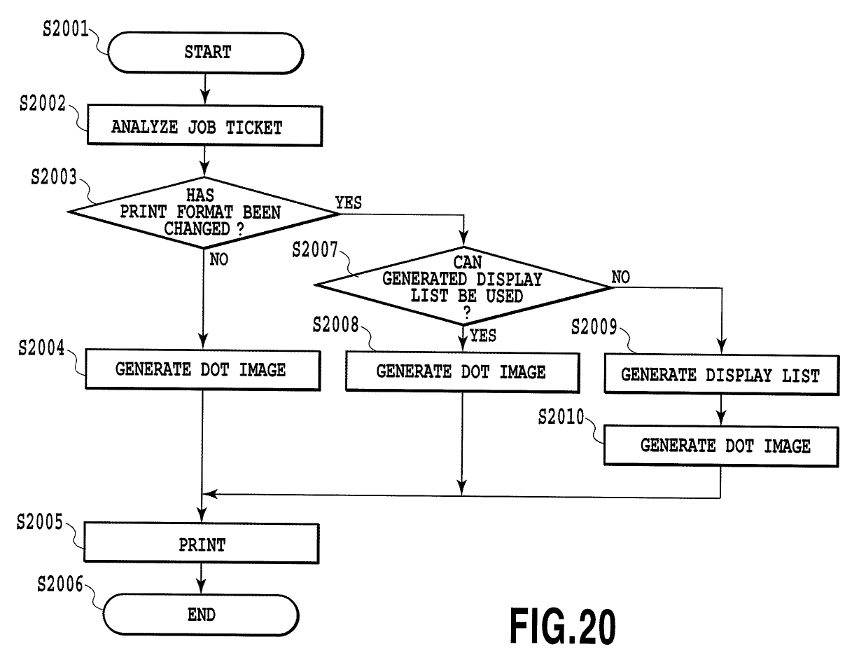

FIG. 20 shows an example of a detailed flow in which the image forming apparatus 111 performs the printing process (in step S1404 in FIG. 14) in order to reprint the job once saved.

When the image forming apparatus 111 receives a print instruction from a user through the “print” button 1002 on the “saved jobs” tab page 1000 shown in FIG. 10, the image forming apparatus 111 is designed to perform the printing process without changing the print format. In contrast, when the image forming apparatus 111 receives a print instruction from the user through the “change format to print” button 1003 on the “saved pages” tab page 1000, the image forming apparatus 111 is designed to perform the print process by changing the print format.

Upon receipt of the print instruction, the image forming apparatus 111 analyzes the print format described in the meta data 1502 (x6) in the printing job (in step S2002).

In the case where the image forming apparatus 111 performs the printing process without changing the print format, the image forming apparatus 111 converts the first intermediate data into a dot image (in step S2004), and thus prints the dot image (in step S2005), subsequently ending the process (in step S2006). In this respect, the first intermediate data is the display list which is generated in step S1903 (in FIG. 19), and which reflects the print format specified in the job ticket.

In the case where the image forming apparatus 111 determines in step S2003 that the printing process should be performed by changing the print format, the image forming apparatus 111 analyzes whether or not the display list as the first intermediate data previously having being generated depending on the result of the determination can be used again in accordance with determination made by the main controller 11106 (in step 2007).

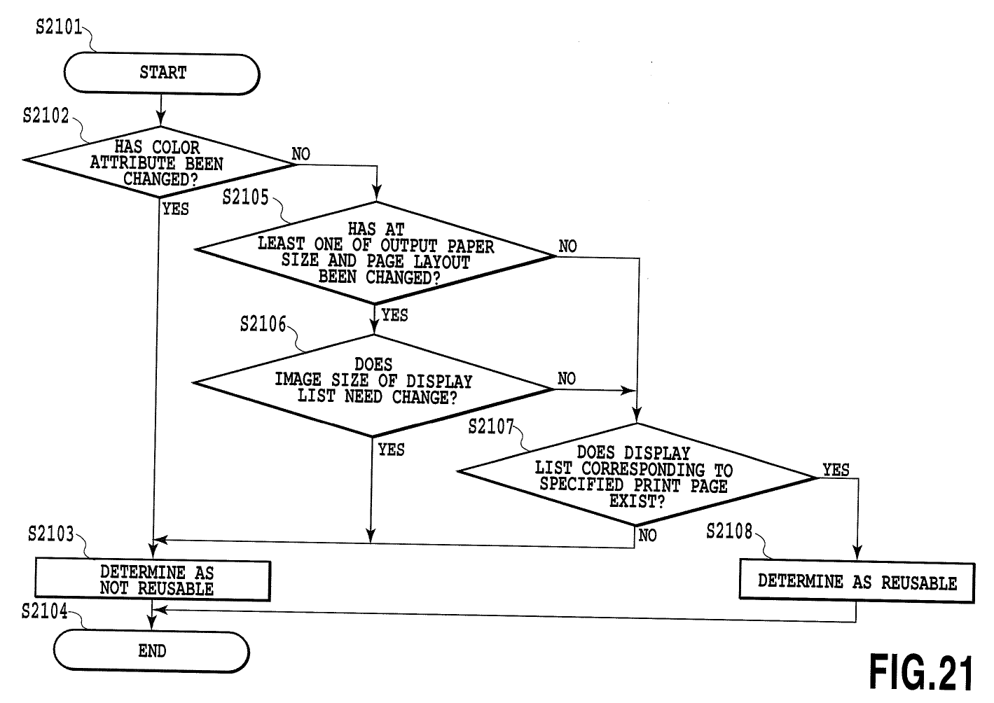

In this embodiment, whether or not the display list previously having been generated can be used again is judged in accordance with a flow for judgment on print format change, which is shown in FIG. 21.

First of all, it is judged in step S2102 whether or not the job format change is related to the color attribute. In this respect, if it is determined that the color attribute needs to be changed, the process proceeds to step S2103, where it is determined that the display list cannot be reused.

In contrast, if it is determined that the color attribute need not be changed, the process proceeds to step S2105, where it is judged whether any one or both of the output sheet size and the page layout need to be changed.

In this respect, if it is determined that neither the output sheet size nor the page layout need be changed, the process proceeds to step S2107. If it is determined that at least one of the output sheet size and the page layout needs to be changed, the process proceeds to step S2106.

In step S2106, it is judged whether or not the image size of the display list needs to be changed. If it is determined that the image size thereof need not be changed, the process proceeds to step S2107. In contrast, if it is determined that the image size thereof needs to be changed, it is determined that the display list cannot be reused (in step S2103).

If a negative determination is made in any one of steps S2105 and S2106, it is judged in step S2107 whether or not there is a display list which corresponds to the page specified to be printed. If the display list exists, it is determined that this display list previously generated can be reused (in step S2108).

In a case where, for instance, the display list reflects all the pages of the application data, if only specific page (s) is instructed to be printed out of all the pages thereof, it is determined that the display list previously generated can be reused. Furthermore, in a case where the display list has been previously generated with an output size of “A4” and with a page layout of “not specified,” if a format changing instruction is made in order to change the output size to “A3” and the page layout to “2 pages on sheet,” it is determined that the display list can be reused. That is because the image size of the display list remains unchanged.

In contrast, in a case where the display list has been previously generated reflecting a color attribute of “monochrome,” if an format changing instruction is made to change the color attribute to “color,” it is determined that the display list previously generated cannot be reused. Furthermore, in a case where the display list has been previously generated with an output size of “A4” and with a page layout of “not specified,” if a format changing instruction is made to change the output size to “A4” and the page layout to “2 pages on sheet,” it is determined that the display list previously generated cannot be reused. That is because the image size thereof needs to be changed.

Return to FIG. 20. In the process of making judgments in accordance with the above-described flow in step S2007, if it is determined that the display list previously generated can be reused, the process proceeds to step S2008.

In step S2008, the display list previously generated is edited depending on the necessity, and the resultant display list is converted into a dot image. Subsequently, the printing process is performed in step S2005, and the process is ended (in step S2006).

In contrast, if it is determined in step S2007 that the display list previously generated cannot be reused, a new display list is generated from the second vector data depending on a result of the determination (in step S2009). The display list newly generated with the new print format reflected will be referred to as “third intermediate data.”

After the display list is newly generated, the newly-generated display list as the third intermediate data is converted into a dot image in step S2010. Subsequently, the printing process is performed in step S2005, and the process is ended (in step S2006).

Hereinafter, the printing performed in each of steps S2004 and S2008 with no new display list being newly generated from the display list as the second intermediate data will be referred to as a “first printing.”

In addition, hereinafter, the printing performed in each of steps S2009 and S2010 with the display list as the third intermediate data being newly generated from the second intermediate data will be referred to as a “second printing.”

The foregoing configuration according to embodiment 1 makes it possible to change a print format when the printing job transmitted from the information processing apparatus 101 is printed with the image forming apparatus 111.

In particular, the configuration according to embodiment 1 makes it possible to print page(s) of a printing job which are not specified when the job is transmitted from the information processing apparatus 101 to the image forming apparatus 111, and to print a printing job in color even if the monochrome attribute is specified for printing when the job is transmitted from the information processing apparatus 101 to the image forming apparatus 111.

### Embodiment 2

As described below, this embodiment is carried out as another control method which is performed to change a print format from one to another in a case where: a printing job is transmitted from an information processing apparatus to an image forming apparatus; the image forming apparatus saves the printing job; and a user prints the printing job having been saved in the image forming apparatus.

This embodiment is different from embodiment 1 in that the display list is generated by the printer driver 10102 of the information processing apparatus 111 instead of by the image forming apparatus 101.

The network configuration, the internal configuration of the information processing apparatus, the internal configuration of the image forming apparatus, the scheme of the overall sequence and the like which are used in this embodiment are the same as those which are used in embodiment 1. For this reason, detailed descriptions for them will be omitted.

Hereinbelow, descriptions will be provided only for a process of generating a printing job which is carried out by the information processing apparatus 101, and a process of saving the printing job which is carried out by the image forming apparatus 111.

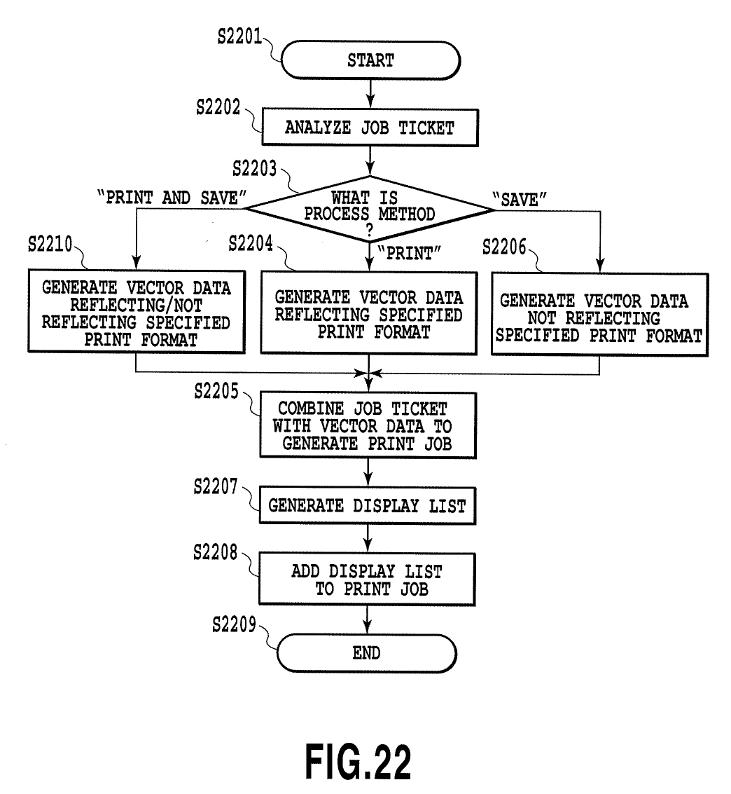

FIG. 22 shows an example of a detailed flow in which the process of generating a printing job is carried out in step (shown in FIG. 13).

Upon receipt of a print instruction, the printer driver 10102 analyzes the contents of the job ticket 700 or the job ticket 800 which have been previously generated (in step S2202).

If the processing method described in the job ticket is “print,” the printer driver 10102 generates first vector data reflecting the print format specified in the job ticket (in step S2204).

In a case where, for instance, the output sheet size is specified as “A4” and the page layout is specified as “2 pages on sheet,” the printer driver 10102 generates vector data 1501 in A5 size on the basis of the application data, and describes in the page header (x2) that the rendering should be carried out with the “2 pages on sheet” page layout. In a case where the pages to be printed are specified as “5, 6,” the printer driver 10102 generates only the 5th and 6th pages of the application data as the vector data 1501. In a case where the color attribute is specified as “monochrome,” the printer driver 10102 generates the vector data 1501 with the “monochrome” specification even if the application data is polychrome.

The vector data (first vector data) generated with the print format reflected in this manner is of a type which makes the print format unsuitable to be changed by the image forming apparatus 111.

After generating the vector data reflecting the print format in step S2204, the printer driver 10102 additionally describes the print format, which is described in the job ticket, in the (x6) part of the meta data 1502 in the printing job (in step S2205).

Subsequently, on the basis of the vector data 1501 thus generated, the printer driver 10102 generates a display list 1503, as the first intermediate data reflecting the print format (in step S2207).

Thereafter, the printer driver 10102 adds the display list to the printing job (in step S2208), and then ends the printing-job generating process (in step S2209).

In contrast, if it is determined in step S2202 that the processing method described in the job ticket is “save,” the printer driver 10102 generates second vector data with the print format specified in the job ticket being not reflected on the second vector data (in step S2206).

Even in a case where, for instance, the output sheet size is specified as “A4” and the page layout is specified as “2 pages on sheet,” the printer driver 10102 generates vector data 1501 with the sizes of the respective pages of the application data. Even in a case where the pages to be printed are specified as “5, 6”, the printer driver 10102 generates vector data 1501 covering all the pages of the application data. Even in a case where the color attribute is specified as “monochrome,” the printer driver 10102 generates vector data 1501 in which the color attribute of the application data is reflected.

The print format of the vector data (second vector data) generated with the print format being not reflected on the vector data in this manner is capable of being changed by the image forming apparatus 111 easily.

After the printer driver 10102 generates the second vector data without reflecting print format in step S2206, the printer driver 10102 performs the process of step S2205. Subsequently, the printer driver 10102 generates first intermediate and second intermediate data in the display generating process of step 2206. After that, the printer driver 10102 performs the process of step S2208, and then ends the printing-job generating process (in step S2209).

On the other hand, if it is determined in step S2202 that the processing method specified in the job ticket is “print and save,” the printer driver 10102 generates both first vector data on which the print format specified in the job ticket is reflected and second vector data on which no print format is reflected (in step S2210). Subsequently, the printer driver 10102 generates first intermediate data and second intermediate data in step S2205, and performs the processes respectively of steps S2207 and S2208, finally ending the printing-job generating process (in step S2209).

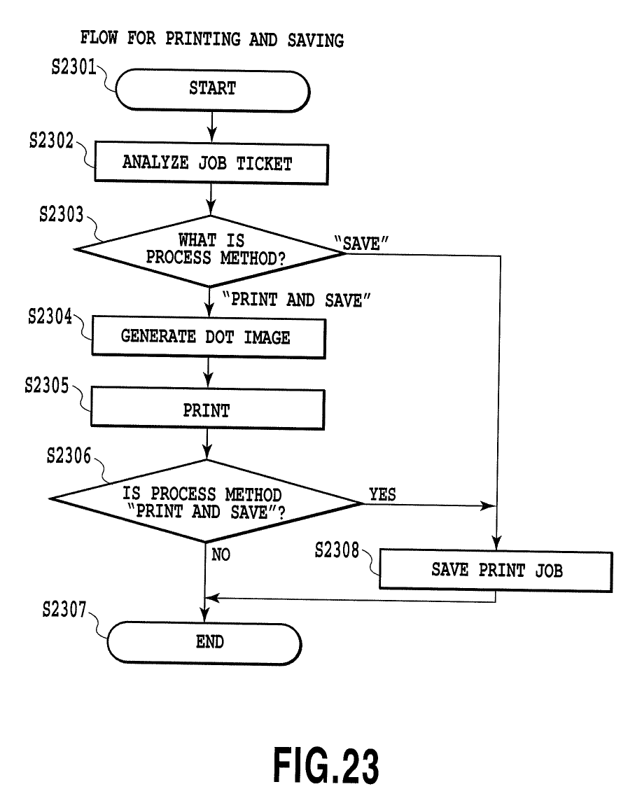

FIG. 23 shows an example of a detailed flow in which the image forming apparatus 111 performs the printing-job generating process (step S1313 shown in FIG. 13).

Upon receipt of a printing job, the image forming apparatus 111 analyzes the print format described in the meta data 1502 (x6) in the printing job (in step S2302), and thereby judges what processing method is specified for the printing job (in step S2303).

If the processing method is specified as “save,” the image forming apparatus 111 stores the printing job in the auxiliary storage 303 (in step S2308). In this respect, the printing job is accompanied by the display list as the second intermediate data previously generated. Subsequently, the image forming apparatus 111 ends the process (in step S2307).

If the image forming apparatus 111 determines in step S2302 that the processing method is “print” or that the processing method is “print and save,” the image forming apparatus 111 converts the display list 1503, as the first intermediate data included in the printing job, into a dot image (in step S2304). Once the dot image is generated, the print controller 11105 prints the dot image by use of the print engine 307 (in step S2305).

Subsequently, the image forming apparatus 111 judges what processing method is specified (in step S2306). If the image forming apparatus 111 determines that the processing method is “print,” the image forming apparatus 111 ends the process without doing anything else (in step S2307). In contrast, if the image forming apparatus 111 determines that the processing method is “print and save,” the image forming apparatus 111 saves the display list as the second intermediate data (in step S2308), and thereafter ends the process.

Like the configuration according to embodiment 1, the foregoing configuration according to embodiment 2 makes it possible to change a print format when the printing job transmitted from the information processing apparatus 101 is printed with the image forming apparatus 111. When the print format is changed, the second vector data included in the second intermediate data is changed.

Like the configuration according to embodiment 1, the configuration according to embodiment 2 makes it possible to print page(s) of a printing job which are not specified when the job is transmitted from the information processing apparatus 101 to the image forming apparatus 111, and to print a printing job in color even if the monochrome attribute is specified for printing when the job is transmitted from the information processing apparatus 101 to the image forming apparatus 111. Furthermore, the configuration according to this embodiment is capable of reducing the process load which is imposed on the image forming apparatus, because the intermediate data is generated by the driver in the image forming apparatus.

### Embodiment 3

This embodiment is carried out as a control method which is performed in a case where: a printing job is stored in an image forming apparatus; and another image forming apparatus obtains the printing job through a network, and prints the obtained printing job.

The network configuration, the internal configuration of the information processing apparatus, the internal configuration of the image forming apparatus and the like which are used in this embodiment are the same as those which are used in embodiment 1. For this reason, detailed descriptions for them will be omitted.

Hereinbelow, descriptions will be provided for the processes which are respectively performed by the image forming apparatus 111 and the image forming apparatus 112, and which are characteristic of this embodiment.

When vector data is polychrome data and a current display list is generated with a monochrome attribute, if an image forming apparatus used for printing has a color printing capability, a new display list with the color attribute of “polychrome” is generated on the basis of the vector information, and a color printing is performed in this embodiment.

Furthermore, when the output size attribute included in vector data is “A3” and a current display list is generated with an “A4” size, if an image forming apparatus used for printing has an A3-sized printing capability, a new display list with the “A3” size is generated on the basis of the vector data, and the printing in the “A3” size is performed in this embodiment.

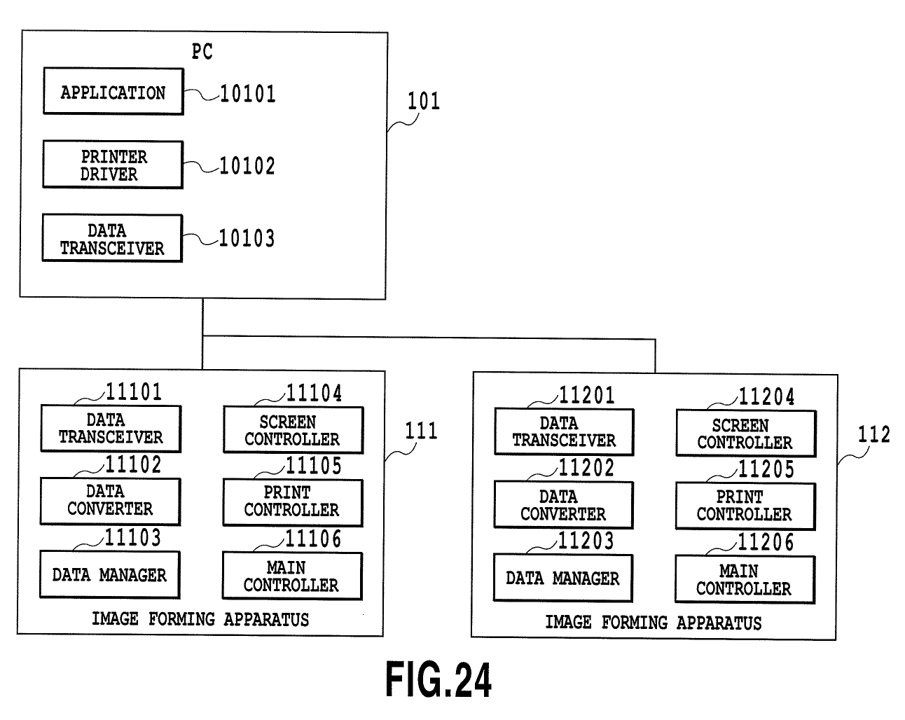

FIG. 24 shows program configurations to be used for this embodiment.

The program configurations respectively of the information processing apparatus 101 and the image forming apparatus 111 used for this embodiment are the same as those used for embodiment 1. For this reason, descriptions for them will be omitted.

The image forming apparatus 112 includes a data transmitter/receiver 11201, a data converter 11202, a data manager 11203, a screen controller 11204, a print controller 11205 and a main controller 11206. This program configuration is operated on a basis of determination made by the CPU 201 shown in FIG. 2.

The main controller 11206 is a program module for controlling the image forming apparatus 112 according to this embodiment overall. The data transmitter/receiver 11201 is capable of transmitting a printing job to, and receiving a printing job from, the image forming apparatus 112 through the NIC 306.

On a basis of an instruction from the main controller 11206, the data converter 11202 converts the format of the printing job, received from the image forming apparatus 111, into a format with which the print engine 307 is capable of performing a printing process.

On a basis of an instruction from the main controller 11206, the print controller 11205 performs a print control on the data so formatted as to be printable, which is generated by the data converter 11202, by use of the printer driver 307. On a basis of an instruction from the main controller 11206, the data manager 11203 is used when the data is saved in the auxiliary storage 303, and when the data saved in the auxiliary storage 303 is loaded in the RAM 302 or the like.

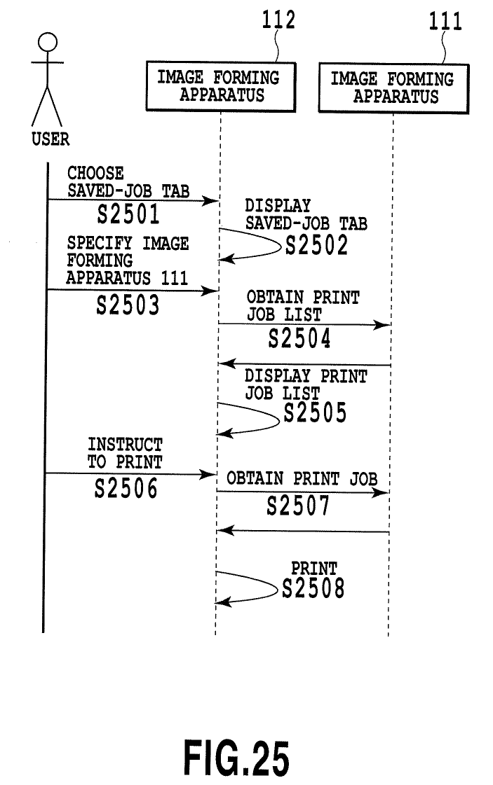

FIG. 25 shows an example of a sequence showing the scheme of a printing flow according to this embodiment.

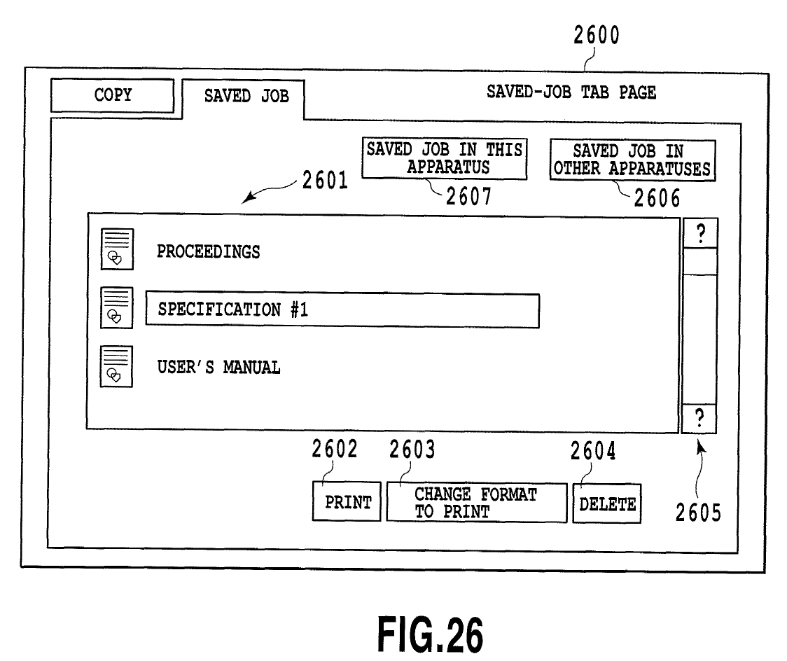

Once a user chooses a “saved jobs” tab page in the image forming apparatus 112 (in step S2501), the image controller 11204 of the image forming apparatus 112 displays a screen shown in FIG. 26 (in step S2502).

At this time, if the user presses a “jobs saved in other apparatuses” button 2606 on a “saved jobs” tab page 2600 shown in FIG. 26 and specifies the image forming apparatus 111 (in step S2503), the main controller 11206 of the image forming apparatus 112 obtains a list of jobs for printing, which have been saved in the image forming apparatus 111, from the image forming apparatus 111 (in step S2504).

In this embodiment, the image forming apparatuses 111, 112 are set up in order that the image forming apparatuses 111, 112 start to communicate with each other once the “jobs saved in other apparatuses” button 2606 on the “saved jobs” tab page 2600 is pressed.

The image forming apparatus 112 may be of a type which is capable of choosing any one of multiple other image forming apparatuses. However, in this embodiment, the image forming apparatus 112 is of the above-described type for simplifying explanation.

Once the image forming apparatus 112 obtains the list of jobs for printing in step S2504, the image forming apparatus 112 displays the obtained list of jobs for printing on a job displaying section 2601 in the “saved jobs” tab page 2600 (in step S2505).

Once the image forming apparatus 112 receives a print instruction from the user in response to the user's choice of an arbitrary printing job (in step S2506), the image forming apparatus 112 obtains data on the printing job from the image forming apparatus 111 (in step S2507), and prints the obtained printing job (in step S2508).

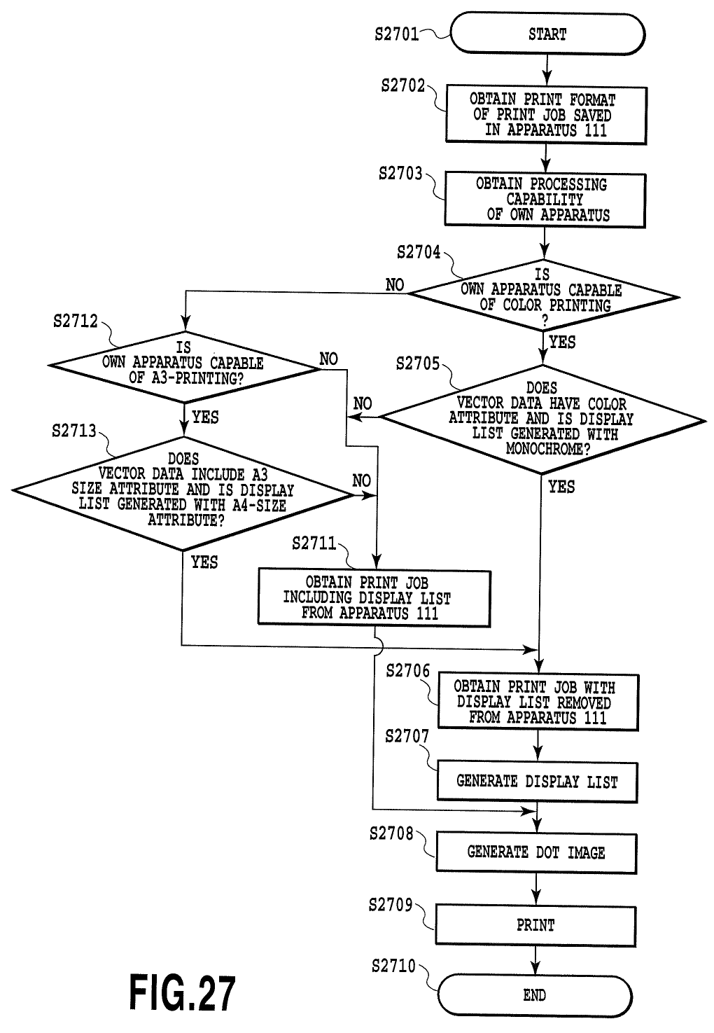

FIG. 27 shows an example of a detailed flow of each of the printing-job acquiring process S2507 and the printing process S2508 shown in FIG. 25.

Once the image forming apparatus 112 receives the print instruction from the user in response to the user's specifying of the printing job through the screen shown in FIG. 26 (in step S2506), the main controller 11206 of the image forming apparatus 112 obtains a print format for the specified printing job from the image forming apparatus 111 (in step S2702).

Subsequently, the image forming apparatus 112 checks its own process capability (in step S2703).

In a case where, judging from its own process capability, the image forming apparatus 112 determines in step S2704 that it is capable of performing a color printing, depending on a result of the determination, the image forming apparatus 112 judges whether or not the vector data on the desired printing job is polychrome, and whether or not the display list as intermediate data has been generated with a “monochrome” attribute (in step S2705).

In a case where the display list has been generated with a “monochrome” attribute, the display list generated for a monochrome printing is not necessary because the apparatus which actually performs a printing is capable of performing a color printing. Consequently, the main controller 11206 obtains the printing job with the display list removed, from the image forming apparatus 111 (in step S2706).

Thereafter, the image forming apparatus 112 generates a display list with a color setting from the vector data included in the obtained printing job (in step S2707), and generates a dot image from the display list thus generated (in step S2708), as well as performs the printing process (in step S2709).

In contrast, if the image forming apparatus 112 determines in step S2705 that the display list has been generated with the color attribute of “polychrome,” the image forming apparatus 112 follows this determination result, obtains the printing job, including the display list, from the image forming apparatus 111 (in step S2711), and proceeds to the processes respectively of step S2708 and the ensuing steps.

On the other hand, if the image forming apparatus 112 determines in step S2704 that it has no color printing capability, the image forming apparatus 112 proceeds to the process of step S2712 in order to judge what the output size attribute is.

In step S2712, the image forming apparatus 112 judges whether or not it has a printing capability of A3-sized sheet.

If the image forming apparatus 112 determines that it has the A3-sized printing capability, the image forming apparatus 112 judges whether or not the display list of the printing job has been generated with the output size attribute of A4 size, and whether or not the vector data has been generated with the output size attribute of A3 size (in step S2713).

If the vector data has been generated with the output size attribute of A3 size and the display list has been generated with the output size attribute of A4 size, the image forming apparatus 112 obtains data on the printing job, excluding the display list, from the image forming apparatus 111 (in step S2706).

Subsequently, the image forming apparatus 112 generates a display list with a color setting from the vector data included in the obtained printing job (in step S2707), and generates an image data from the display list thus generated (in step S2708), as well as performs the printing process (in step S2709).

In contrast, if the image forming apparatus 112 determines in step S2712 that it has no A3-sized printing capability, and if the image forming apparatus 112 makes a negative determination in step S2713, the image forming apparatus 112 proceeds to the process of S2711.

The foregoing configuration makes it possible to change a print format in the case where: a printing job is transmitted from the information processing apparatus 101 to the image forming apparatus 111; the printing job is stored in the image forming apparatus 111; and the image forming apparatus 112 obtains the printing job from the image forming apparatus 111 through a network, and prints the obtained printing job.

In particular, the foregoing configuration makes it possible to print pages of the printing job which are not specified when the job is transmitted from the information processing apparatus 101 to the image forming apparatus 111, and to print the job in color even if the monochrome attribute is specified when the job is transmitted from the information processing apparatus 101 to the image forming apparatus 111. Furthermore, even when the printing job is saved in the image forming apparatus 111, the foregoing configuration makes it possible for the printing job to be used by the different image forming apparatus 112 through the network.

### Embodiment 4

This embodiment is described as being carried out as a linkage relationship between the arbitrary application 10101 and the printer driver 10102 of the information processing apparatus 101, whose type is different from that of the linkage relationship between the arbitrary application 10101 and the printer driver 10102 of the information processing apparatus 101 according to embodiment 1.

In order to perform its processes, an image forming apparatus according to the present is designed to be capable of using the foregoing configurations used for the processes performed by the image forming apparatus according to each of embodiment 1, embodiment 2 and embodiment 3. For this reason, descriptions for the configurations will be omitted.

Hereinafter, descriptions will be provided only for the processes performed by each of the arbitrary application 10101 and the printer driver 10102.

Like the embodiment 1, the printer driver 10102 according to this embodiment has the function to specify a print format. In addition, unlike the arbitrary application 10101 according to embodiment 1, the arbitrary application 10101 according to this embodiment has the function to specify a print format in its printing screen.

In some cases, the printer driver 10102 may operate only within a scope of a print format specified by the arbitrary application 10101, depending on what OS (standing for Operating System) is used for the information processing apparatus or what printing system is installed in the OS used for the information processing apparatus. For instance, when pages to be printed are specified by use of a print format screen displayed by the arbitrary application 10101, the printer driver may be controllable only in a range of the pages thus specified in some cases.

This embodiment makes it possible to generate a desired printing job with consistency with both a print format setup specified by use of the arbitrary application 10101 and a print format setup specified by use of the printer driver 10102.

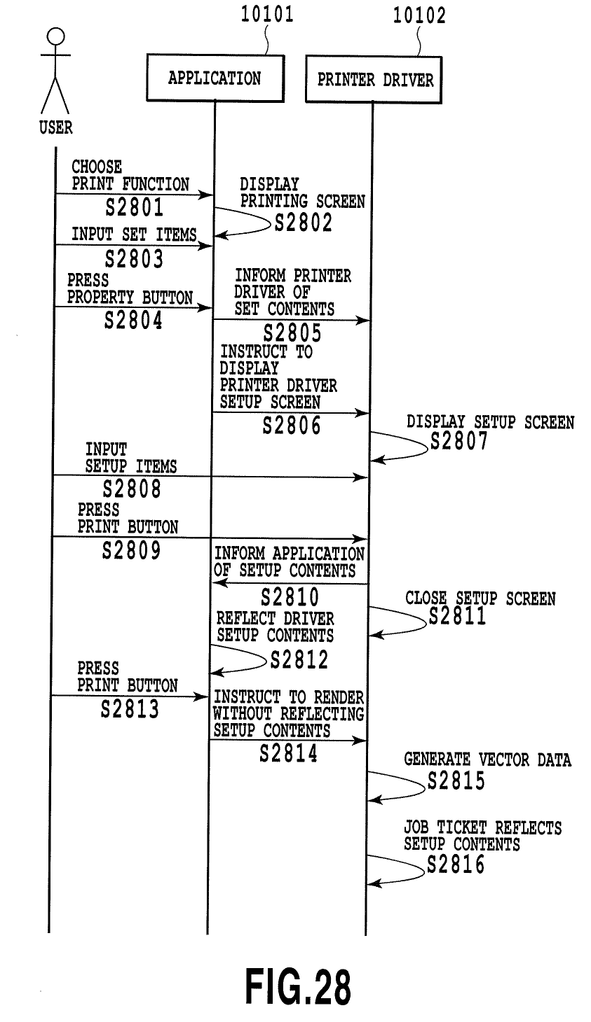

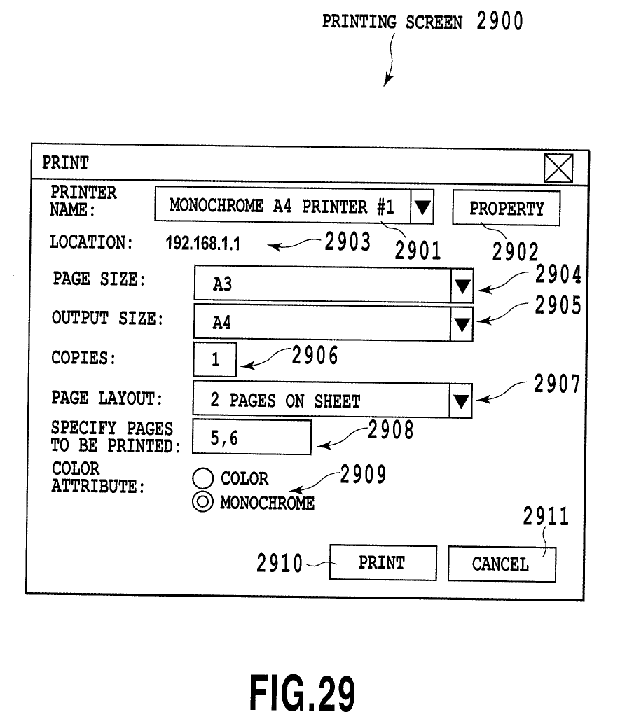

FIG. 28 shows a sequence in which the arbitrary application 10101 and the print driver 10102 perform their respective processes, and which is used for this embodiment. FIG. 29 shows a printing screen which is prepared by the arbitrary application.

A printer object specifying area 2901 and a property button 2902, both shown in FIG. 29, are the same as to the printer object selecting section 501 and the property button 502 for specifying a print format of the printer object, both shown in FIG. 5.

FIG. 29 shows that the arbitrary application 10101 according to this embodiment includes an original size specifier 2904, an output sheet size specifier 2905, a number-of-copies specifier 2906, a page layout specifier 2907, a page-to-be-printed specifier 2908 and a print color specifier 2909.

The contents specified by the respective specifiers are the same as the contents specified by use of the respective sections in the printer driver setup screen 600. The printer driver setup screen 600 described in embodiment 1 can be used as a screen through which to set up the printer driver 10102.

In FIG. 28, once the printing function included in the arbitrary application 10101 is chosen by a user (in step S2801), the arbitrary application 10101 causes a printing screen 2900 shown in FIG. 29 to be displayed (in step S2802). The printer driver setup screen 600 allows the user to set up various print format items corresponding to the respective specifiers 2904 to 2909 (in step S2803).

Subsequently, once the property button 2902 is pressed (in step S2804), the arbitrary application 10101 informs the printer driver 10102 of the various print format items thus set up (in step S2805). In addition, the arbitrary application 10101 instructs the printer driver 10102 to display the printer driver setup screen (in step S2806).

In response to the instruction, the printer driver 10102 displays the printer driver setup screen 600 (in step S2807). In this respect, the printer driver setup screen 600 is designed to reflect the contents of the specifications made by use of the specifiers 2904 to 2909 on the printing screen 2900, respectively.

The user edits arbitrary setup items and inputs the resultant items by use of the printer driver setup screen 600 (in step S2808). Thereafter, once the print button 607 is pressed (in step S2809), the printer driver 10102 informs the arbitrary application 10101 of the print format items thus set up (in step S2810), and closes the printer driver setup screen 600 (in step S2811).

Simultaneously with the closure of the screen 600, the arbitrary application 10101 reflects the informed print format items on the respective specifiers 2904 to 2909 in the printing screen 2900 (in step S2812).

At this time, once the user presses the print button 2910 (in step S2813), the arbitrary application 10101 gives a render instruction to the printer driver 10102 without reflection of any print format (in step S2814). The reason why the render instruction is given without reflecting any print format is that the arbitrary application 10101 intends to send a print instruction along with a default job ticket 800.

The printer driver 10102 generates vector data without reflection of any print format on the vector data as instructed by the arbitrary application 10101 (in step S2815), and reflects the print setup items on the job ticket (in step S2816).

With regard to step S2805, no specific restriction is imposed on a method with which the arbitrary application 10101 informs the printer driver 10102 of the contents thus set up.

In a case where, for instance, the arbitrary application 10101 and the printer driver 10102 are operating for the same process, the contents thus set up can be informed as an argument for calling API (standing for Application Programs Interface). Otherwise, in a case where the arbitrary application 10101 and the printer driver 10102 are operating for their respective different processes, the contents thus set up can be informed by use of a method complying data exchanging methods for inter-process communications (informing by use of an API argument of RPC (standing for Remote Procedure Call), informing through a shared file, informing through registry information, and the like).

The foregoing configuration according to embodiment 4 makes it possible to change a print format of a printing job, which has been transmitted from the information processing apparatus 101 to the image forming apparatus 111, when the printing job is printed by use of the image forming apparatus.

In particular, the foregoing configuration according to embodiment 4 makes it possible to print page(s) of the printing job which are not specified when the printing job is transmitted from the information processing apparatus 101 to the image forming apparatus 111, and to print the printing job in color even if the monochrome attribute is specified when the printing job is transmitted from the information processing apparatus 101 to the image forming apparatus 111.

In the case where the arbitrary application 10101 and the printer driver 10102 have their respective print format specifying screens, the foregoing configuration according to embodiment 4 makes it possible to give a print instruction which is consistent with both the print format set up by use of the arbitrary application 10101 and the print format set up by use of the printer driver 10102 when the printing job is printed by use of the image forming apparatus.

### Embodiment 5

As described in detail later, this embodiment is shown as being carried out as a control method which is used in a case where: the printing job is transmitted from an information processing apparatus to an image forming apparatus; the image forming apparatus stores the printing job; and a user prints the stored printing job with the image forming apparatus by changing its print format.

In embodiment 1, descriptions are provided for the configuration in which the information processing apparatus generates a job ticket and vector data as a printing job.

This embodiment is described as being a type in which: the information processing apparatus generates PDL data as a printing job, and transmits the PDL data to the image forming apparatus; and the image forming apparatus interprets the PDL data, and thus generates vector data and a display list.

The network configuration, the internal configuration of the information processing apparatus, the internal configuration of the image forming apparatus, the scheme of the overall sequence and the like which are used for this embodiment are the same as those which are used for embodiment 1. For this reason, detailed descriptions for them will be omitted.

Hereinbelow, descriptions will be provided only for a process of generating a printing job which is performed by the information processing apparatus 101 and a method of processing the printing job which is performed by the image forming apparatus 111.

As described in the term definitions, PDL is a printer controlling code which is used by a page printer. Various PDLs are known. They includes PostScript®, PCL®, ESC/Page® and LIPS® which are respectively developed by Adobe®, Hewlett-Packard®, Epson® and Canon®. PDLs have their own command systems. For this reason, interpretation of a command makes it possible to identify a data type, a rendering method and the like.

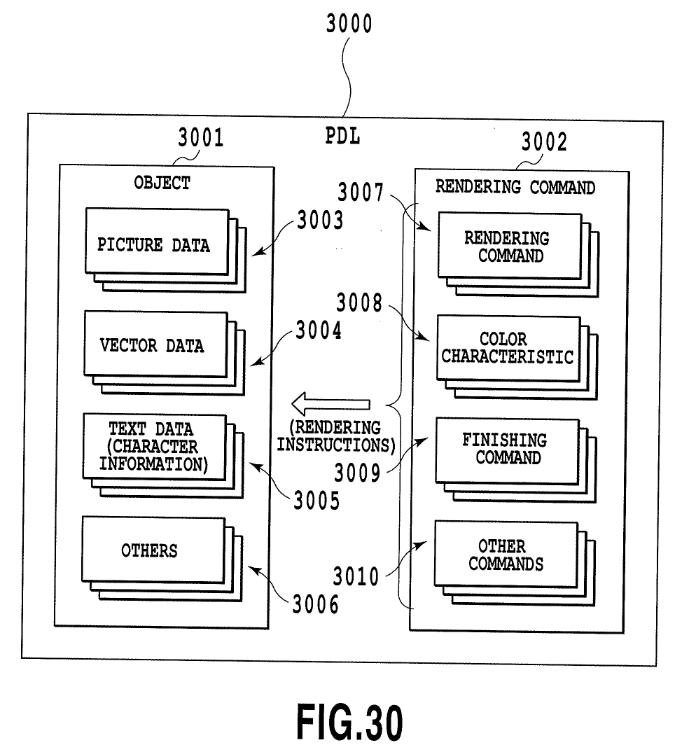

FIG. 30 shows a scheme of components of PDL data which is used for this embodiment.

In this embodiment, the PDL data is configured by including: objects 3001 which is render objects; and rendering commands 3002.

Furthermore, each object 3001 is configured by including picture data 3003, vector data 3004 and text data 3005. Each object 3001 may include other data 3006 as another object component type in addition to the above-mentioned data.

Each rendering command 3002 is configured by including a rendering command 3007, a color characteristic 3008 and a finishing command 3009. Each rendering command 3002 may include other command types (document information, page information and the like) 3010 in addition to the above-mentioned components.

For instance, a picture image included in document data and the like corresponds to the picture data 3003. The vector data 3004 is data configured of geometric graphic elements such as a graph included in document data. The text data 3005 is information on characters included in document data, for instance.

Positional information (layout, coordinates and the like) on how each object should be arranged in a print page corresponds to each rendering command 3007. Information on what color space each object should be processed in, information on what color scheme each object should be represented with, and the like correspond to the color characteristic 3008. Information on how output sheets should be processed corresponds to the finishing command 3009. Examples of the information includes information on what stapling process should be applied to output sheets, and information on what punching process should be applied to output sheets.

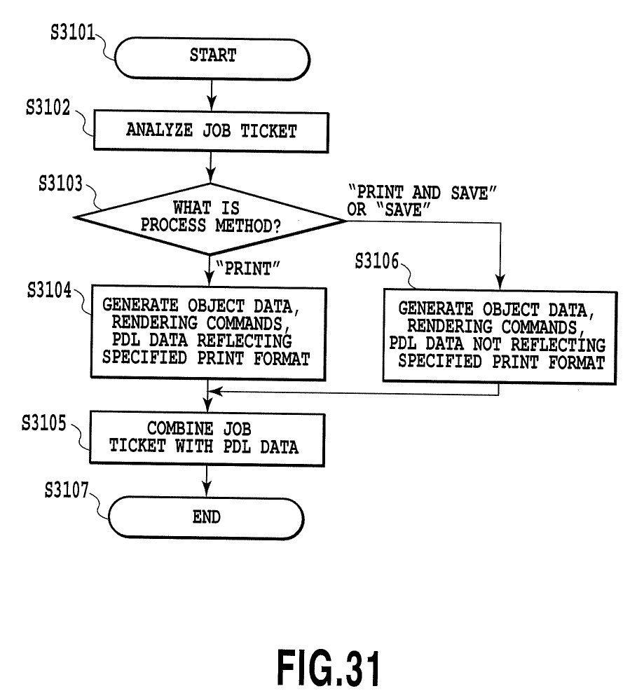

FIG. 31 shows an example of how the information processing apparatus 101 performs a PDL generating process, which is used for this embodiment. Steps S3104 to S3106 shown in FIG. 31 are those obtained by diverting the printing-job generating steps (S1804 to S1806) shown in FIG. 18 to a PDL data process.

The scheme of the overall sequence used for this embodiment is almost the same as the scheme of the overall sequence used for embodiment 1, which is shown in FIG. 13. For this reason, descriptions for it will be omitted.

Upon receipt of a print instruction, the printer driver 10102 analyzes the contents of the job ticket 700 or the job ticket 800 previously generated (in step S3102).

Subsequently, the printer driver 10102 judges what the processing method is (in step S3103). If the printer driver 10102 determines that the processing method is “print,” the printer driver 10102 generates PDL data reflecting the print format specified in the job ticket (in step S3104).

In a case where, for instance, the output sheet size is specified as “A4” and the page layout is specified as “2 pages on sheet,” the printer driver 10102 generates each object 3001 on the basis of the application data in a way that each of the two specified pages can be fitted into an A5 size. In addition, the printer driver 10102 describes contents of a rendering instruction in each rendering command 3002 in order that the rendering should be performed by use of the specified layout.

In a case where the pages to be printed are specified as “5, 6,” the printer driver 10102 generates objects 3001 and rendering commands 3002 concerning on the 5th and 6th pages of the application. In a case where the color attribute is specified as “monochrome,” the printer driver 10102 generates the objects 3001 and the rendering commands 3002 with “monochrome” even if the application data is “polychrome”.

The PDL data generated with the print format being reflected on the PDL data in this manner is of a type which makes the print format unsuitable to be changed by the image forming apparatus 111. Hereinafter, the PDL data with the print format being reflected thereon in this manner will be referred to as “first PDL data.”

Subsequently, the printer driver 10102 additionally describes the print format, which is described in the job ticket, in the PDL data (in step S3105), and then ends the printing-job generating process (in step S3107).

On the other hand, if the printer driver 10102 determines in step S3103 that the processing method specified in the job ticket is “print and save,” or “save,” the printer driver 10102 generates PDL data with the print format specified in the job ticket being not reflected on the PDL data (in step S3106). Hereinafter, the PDL data generated without reflection of any print format on the PDL data in this manner will be referred to as “second PDL data.”

Even in a case where, for instance, the output sheet size is specified as “A4” and the page layout is specified as “2 pages on sheet,” the printer driver 10102 generates the objects 3001 and the rendering commands 3002 reflecting sizes of the respective pages included in the application data. Even in a case where the pages to be printed are specified as “5, 6,” the printer driver 10102 generates the objects 3001 and the rendering commands 3002 covering all the pages included in the application data. Even if the color attribute is specified as “monochrome,” the printer driver 10102 generates the objects 3001 and the rendering commands 3002 reflecting the color attribute of “polychrome” of the application data.

The print format of PDL data generated without reflection of any print format is easily changed by the image forming apparatus 111 as described above.

Upon generation of the PDL data in step S3106, the printer driver 10102 performs the process of S3105, and subsequently ends the printing-job generating process (in step S3107).

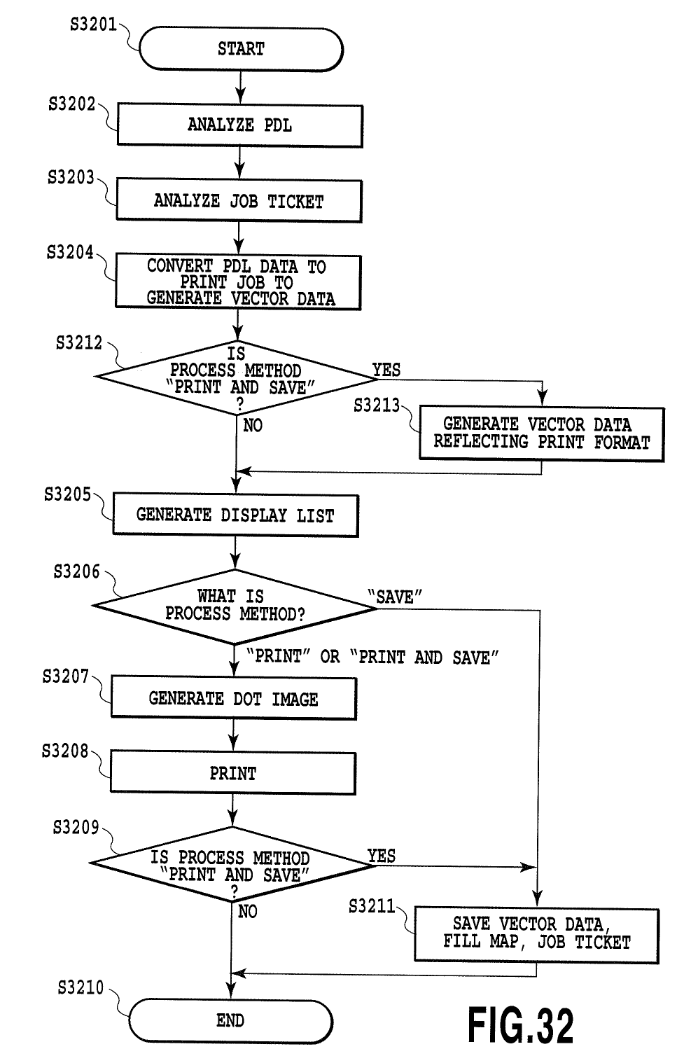

FIG. 32 shows an example of a flow in which the image forming apparatus 111 performs a process when receiving the PDL data.

Steps S3202 to S3205, S3211 shown in FIG. 32 are those obtained by diverting the printing-job processing steps S1902 to S1903, S1909 in the embodiment 1 shown in FIG. 19 to the PDL data process.

The scheme of the overall sequence used for this embodiment is almost the same as the scheme of the overall sequence used for embodiment 1, which is shown in FIG. 14. For this reason, descriptions for it will be omitted.

Upon receipt of the PDL data as the printing job, the main controller 11106 the image forming apparatus 111 analyzes the PDL data (in step S3202). Through this process, the main controller 11106 is capable of analyzing the objects 3001 and the rendering commands 3002 constituting the PDL data as well as the job ticket.

Subsequently, the main controller 11106 analyzes the job ticket (in step S3203), and thus converts the PDL data, which is shown in FIG. 30, into the printing job shown in FIG. 15, thereby generating vector data (in step S3204).

Specifically, the main controller 11106 converts the objects 3001, included in the PDL data 3000, into the respective objects x4 constituting the vector data on the printing job 1500.

In addition, the main controller 11106 converts the rendering commands 3002 into the respective sets of summary information x3 constituting the vector data on the printing job 1500.

Furthermore, on the basis of other commands 3010 included in the rendering commands 3002, the main controller 11106 generates a document header x1 and page headers x2.

At this time point, the document header x1 and the vector data 1501 to be included in the printing job are all generated.

Subsequently, if the main controller 11106 determines in step S3212 that the processing method is “print and save,” the main controller 11106 generates first vector data reflecting the print format as well (in step S3213). Thereafter, the main controller 11106 converts the vector data on the printing job into a display list on the basis of the print format described in the job ticket (in step S3205).

Afterward, the main controller 11106 judges what processing method is described in the job ticket (in step S3206). If “save” is specified as the processing method, the main controller 11106 stores the display list as the previously-generated second intermediate data and the printing job in the auxiliary storage 303 (in step S3211), and ends the process (in step S3210).

On the other hand, if the main controller 11106 determines in step S3206 that the processing method is “print,” or that the processing method is “print and save,” the main controller 11101 further converts the display list as the first intermediate data, which is previously generated in step S3205, into a dot image (in step S3207), and the printer controller 11105 prints the dot image by use of the print engine 307 (in step S3208).

Subsequently, the main controller 11106 judges what the processing method is (in step S3209). If the processing method is specified as “print” but not “print and save,” the image forming apparatus 111 ends the process without doing anything else (in step S3210). If the processing method is “print and save,” the main controller 11106 performs the process step S3211 by use of the second vector data and the second intermediate data, and thereafter the image forming apparatus 111 ends the process (in step S3210).

Through the PDL data analyzing process in step S3202, the main controller 11106 is capable of performing the following processes.

In a case where, for instance, the main controller 11106 detects a character process command, the main controller 11106 is capable of reading font information and a character code included in the character process command, and thus of converting the font information and the character code into character information. In a case where the main controller 11106 detects a graphic process command, the main controller is capable of reading line commands, Bezier commands, filling commands and the like for forming a graphic, and thus of converting the line commands, the Bezier commands, the filling commands and the like into graphic information. In a case where the main controller 11106 detects a graphic process command, the main controller 11106 is capable of reading information on the presence or absence of a compression process in the graphic command, the size and color space of the graphic, and the like, as well as is thus capable of converting the information into graphic information.

The foregoing configuration according to embodiment 5 makes it possible for the present invention to be applied even to a printing system using a general PDL if an image forming apparatus included in the printing system is capable of analyzing the PDL so that the printing system can performs a printing process by use of an arbitrary PDL. In addition, the configuration according to embodiment 5 makes it possible to change a print format of a printing job previously received from an information processing apparatus when the printing job is printed by use of the image forming apparatus.

In particular, the configuration according to embodiment 5 makes it possible to print page(s) of a printing job which are not specified when the printing job is transmitted from the information processing apparatus to the image forming apparatus, and to print a printing job in color which the printing job is specified to be printed in monochrome when the printing job is transmitted from the information processing apparatus to the image forming apparatus.

### Other Embodiments of the Present Invention

The scope of the foregoing embodiments includes a processing method, executed by a computer, of storing programs for operating the configurations according to the foregoing embodiments in a storage in order to realize the functions according to the foregoing embodiments, and thus of reading the programs stored in the storage as codes. It is a matter of course that the scope of the foregoing embodiments includes: the storage in which the programs are stored; and the programs.

For instance, a Floppy® disc, a hard disc, an optical disc, a magneto-optical disc, a CD-ROM, a magnetic tape, an nonvolatile memory card and a ROM are all usable as the storage.

In addition, the scope of the foregoing embodiments includes not only what are processed by use of the individual programs stored in the storage, but also what execute the operations of the respective embodiments by operating on the OS in cooperation with another set of software and a function of an expansion board.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-64694, filed Mar. 13, 2008 which is hereby incorporated by reference herein in its entirety.

What is claimed is:

1. An information processing apparatus for generating a printing job to output data for printing, comprising:
a job ticket generating component configured to generate a job ticket that specifies a print format and a processing method which are used to output said data for printing;
a determination component configured to analyze said job ticket to determine said processing method;
a data generating component configured to generate a printing data or a saving data depending upon a result of the determination, wherein the printing data is a data for print that reflects said print format specified by said job ticket and the saving data is a data for save that does not reflect said print format specified by said job ticket; and
a job transmitting component configured to generate and transmit a printing job, wherein the job includes said job ticket and said printing data or includes said job ticket and said saving data.

2. The apparatus according to claim 1, wherein
said printing data generated by said data generating component is a first vector data as a vector data for said data, and
said saving data generated by said data generating component is a second vector data as vector data for said data.

3. The apparatus according to claim 1, wherein
said printing data generated by said data generating component is a first PDL data as PDL data for said data, and
said saving data generated by said data generating component is a second PDL data as PDL data for said data.

4. The apparatus according to claim 1, wherein
said printing data generated by said data generating component is a first vector data as vector data for said data, and
said saving data generated by said data generating component is a second vector data as vector data for said data,
the apparatus further comprising an intermediate data generating component to generate a first intermediate data from said first vector data generated by said data generating component or a second intermediate data from said second vector data generated by said data generating component, the first intermediate data serving as a base for a dot image used for a printing, and wherein
said job transmitting component adds said first intermediate data and said second intermediate data to said printing job to transmit the resultant printing job.

5. The apparatus according to claim 1, further comprising:
an application for processing data; and
a driver for receiving an instruction to convert data into printing data from said application, wherein
a print format instructed by said driver does not reflect a print format instructed by said application and said job ticket reflects said print format instructed by said driver.

6. An image forming apparatus comprising:
a receiving component configured to receive a printing job;
a determination component configured to analyze a job ticket that specifies a print format and a processing method which are used to output data for printing to determine said processing method, wherein the received printing job includes said job ticket; and
a processing component configured to generate a printing data that reflects said print format to output said data for printing and save a saving data that does not reflect said print format, when it is determined by said determination component that a specified processing method is a print and save process, based upon said saving data that does not reflect said print format and said job ticket, wherein said received printing job includes saving data.

7. The apparatus according to claim 6, wherein
said printing data generated by said processing component and reflecting said print format is a first vector data as a vector data for said data, and
said saving data included in said received printing job by said receiving component is a second vector data as a vector data for said data,
the apparatus further comprising:
a component configured to generate a first intermediate data that reflects said print format from said first vector data; and
a component configured to generate a second intermediate data that does not reflect said print format from said second vector data.

8. The apparatus according to claim 6, wherein
said printing data generated by said processing component and reflecting said print format is a first PDL data as a PDL data for said data, and
said saving data included in said received printing job by said receiving component is a second PDL data as a PDL data for said data,
the apparatus further comprising:
a component configured to generate a first intermediate data from said first PDL data; and
a component configured to generate a second intermediate data from said second PDL data.

9. The apparatus according to claim 6, further comprising:
a format change determination component configured to determine whether or not said print format should be changed when said printing job is reprinted;
a first printing component configured to convert said printing data into a dot image that is a data used for printing to print the resultant data, when said format change determination component determines that said print format should not be changed; and
a second printing component configured to generate a third intermediate data from said saving data reflecting a changed print format and convert said third intermediate data into a dot image that is a data used for printing to print the resultant data, when said format change determination component determines that said print format should be changed and that said printing data is unusable.

10. The apparatus according to claim 6, further comprising:
an application for processing data; and
a driver for receiving an instruction to convert data into printing data from said application, wherein
a print format instructed by said driver does not reflect a print format instructed by said application and said job ticket reflects said print format instructed by said driver.

11. An information processing method of generating a printing job to output data for printing, comprising the steps of:
generating a job ticket that specifies a print format and a processing method which are used to output said data for printing;
analyzing said job ticket to determine said processing method;
generating a printing data or a saving data depending upon a result of the determination, wherein the printing data is a data for print that reflects said print format specified by said job ticket and the saving data is a data for save that does not reflect said print format specified by said job ticket; and
generating and transmitting a printing job, wherein the job includes said job ticket and said printing data or includes said job ticket and said saving data.

12. A method of forming an image comprising the steps of:
receiving a printing job;
analyzing a job ticket that specifies a print format and a processing method which are used to output data for printing to determine said processing method, wherein the received printing job includes said job ticket; and
generating a printing data that reflects said print format to output said data for printing and save a saving data that does not reflect said print format, when it is determined in the analyzing step that a specified processing method is a print and save process, based upon said saving data that does not reflect said print format and said job ticket, wherein said received printing job includes saving data.

13. The method according to claim 12, further comprising the steps of:
determining whether or not said print format should be changed when said printing job is reprinted;
converting said printing data into a dot image that is a data used for printing to print the resultant data, when it is determined in said format change determining step that said print format should not be changed; and
generating a third intermediate data from said saving data reflecting a changed print format and convert said third intermediate data into a dot image that is a data used for printing to print the resultant data, when it is determined in said format change determining step that said print format should be changed and that said printing data is unusable.

14. An image forming system comprising:
a job ticket generating component configured to generate a job ticket that specifies a print format and a processing method which are used to output said data for printing;
a first determination component configured to analyze said job ticket to determine said processing method;
a data generating component configured to generate a printing data or a saving data depending upon a result of the determination, wherein the printing data is a data for print that reflects said print format specified by said job ticket and the saving data is a data for save that does not reflect said print format specified by said job ticket;
a job transmitting component configured to generate and transmit a printing job, wherein the job includes said job ticket and said printing data or includes said job ticket and said saving data;
a receiving component configured to receive said printing job;
a second determination component configured to analyze said job ticket included in the received printing job to determine said processing method; and
a processing component configured to generate a printing data that reflects said print format to output said data for printing and save a saving data that does not reflect said print format, when it is determined by said second determination component that a specified processing method is a print and save process, based upon said saving data and said job ticket, wherein said received printing job includes saving data.
